(19) United States
(12) Patent Application Publication
(10) Pub. No.: US 2024/0221279 A1
(43) Pub. Date: Jul. 4, 2024

(54) SLICED GRAPHICS PROCESSING UNIT (GPU) ARCHITECTURE IN PROCESSOR-BASED DEVICES

(71) Applicant: QUALCOMM Incorporated, San Diego, CA (US)

(72) Inventors: Xuefeng Tang, San Diego, CA (US); Jian Liang, San Diego, CA (US); Tao Wang, Sunnyvale, CA (US); Dong Zhou, San Diego, CA (US)

(21) Appl. No.: 18/609,624

(22) Filed: Mar. 19, 2024

Related U.S. Application Data
(63) Continuation-in-part of application No. 18/320,792, filed on May 19, 2023.
Application No. 18/320,792 is a continuation of application No. 18/067,837, filed on Dec. 19, 2022.
(60) Provisional application No. 63/374,286, filed on Sep. 1, 2022.

(51) Int. Cl. G06T 15/00

(52) U.S. Cl. CPC G06T 15/005

(57) ABSTRACT

A sliced graphics processing unit (GPU) architecture in processor-based devices is disclosed. In some aspects, a GPU based on a sliced GPU architecture includes multiple hardware slices. The GPU further includes a sliced low-resolution Z buffer (LRZ) that is communicatively coupled to each hardware slice of the plurality of hardware slices, and that comprises a plurality of LRZ regions. Each hardware slice is configured to store, in an LRZ region corresponding exclusively to the hardware slice among the plurality of LRZ regions, a pixel tile assigned to the hardware slice.

### PRIORITY APPLICATIONS

The present application for patent is a Continuation-in-Part of U.S. patent application Ser. No. 18/320,792, filed on May 19, 2023 and entitled “SLICED GRAPHICS PROCESSING UNIT (GPU) ARCHITECTURE IN PROCESSOR-BASED DEVICES,” which is incorporated herein by reference in its entirety.

U.S. patent application Ser. No. 18/320,792 is a continuation of U.S. patent application Ser. No. 18/067,837, filed on Dec. 19, 2022 and entitled “SLICED GRAPHICS PROCESSING UNIT (GPU) ARCHITECTURE IN PROCESSOR-BASED DEVICES,” which is incorporated herein by reference in its entirety.

U.S. patent application Ser. No. 18/067,837 claims the benefit of U.S. Provisional Patent Application Ser. No. 63/374,286, filed on Sep. 1, 2022 and entitled “SLICED GRAPHICS PROCESSING UNIT (GPU) ARCHITECTURE IN PROCESSOR-BASED DEVICES,” which is incorporated herein by reference in its entirety.

### TECHNICAL FIELD

The technology of the disclosure relates generally to graphics processing unit (GPU) architectures in processor-based devices.

### BACKGROUND

Modern processor-based devices include a dedicated processing unit known as a graphics processing unit (GPU) to accelerate the rendering of graphics and video data for display. A GPU may be implemented as an integrated element of a general-purpose central processing unit (CPU), or as a discrete hardware element that is separate from the CPU. Due to their highly parallel architecture and structure, a GPU is capable of executing algorithms that process large blocks of data in parallel more efficiently than general-purpose CPUs. For example, GPUs may use a mode known as “tile rendering” or “bin-based rendering” to render a three-dimensional (3D) graphics image. The GPU subdivides an image, which can be decomposed into triangles, into a number of smaller tiles. The GPU then determines which triangles making up the image are visible in each tile and renders each tile in succession, using fast on-chip memory in the GPU to hold the portion of the image inside the tile. Once the tile has been rendered, the on-chip memory is copied out to its proper location in system memory for outputting to a display, and the next tile is rendered.

The process of rendering a tile by the GPU can be further subdivided into multiple operations that may be performed concurrently in separate processor cores or graphics hardware pipelines. For example, tile rendering may involve a tile visibility thread executing on a first processor core, a rendering thread executing on a second processor core, and a resolve thread executing on a third processor core. The purpose of the tile visibility thread is to determine which triangles contribute fragments to each of the tiles, with the result being a visibility stream that contains a bit for each triangle that was checked, and that indicates whether the triangle was visible in a given tile. The visibility stream is compressed and written into the system memory. The GPU also executes a rendering thread to draw the portion of the image located inside each tile, and to perform pixel rasterization and shading. Triangles that are not culled by the visibility stream check are rendered by this thread. Finally, the GPU may also execute a resolve thread to copy the portion of the image contained in each tile out to the system memory. After the rendering of a tile is complete, color content of the rendered tile is resolved into the system memory before proceeding to the next tile.

In response to market pressures to produce GPUs that are capable of higher levels of performance, GPU manufacturers have begun to scale up the physical size of the GPU. However, the implementation of a conventional GPU architecture in a larger physical size does not necessarily result in improved performance and can even raise issues not encountered with smaller GPU. For example, with smaller GPUs, increasing voltage results in a correspondingly increased maximum frequency, reflecting a generally linear relationship between voltage and frequency. Because wire delay also plays a large role in determining maximum frequency, though, increasing voltage in larger GPUs beyond a particular point will not increase maximum frequency in a linear fashion. Moreover, because GPUs are configured to operate as Single Instruction Multiple Data (SIMD) processors, they are most efficient when operating on large quantities of data. Because larger GPUs require workloads to be distributed as smaller data chunks, they may not be able to fill each processing pipeline sufficiently to mask latency issues incurred by memory fetches. Additionally, differences in workload and execution speed within different pipelines within the GPU, as well as different execution bottlenecks (i.e., Double Data Rate (DDR) memory bottlenecks versus internal GPU bottlenecks), may also cause larger GPU sizes to fail to translate into GPU performance gains.

### SUMMARY OF THE DISCLOSURE

Aspects disclosed in the detailed description include a sliced graphics processing unit (GPU) architecture in processor-based devices. Related apparatus and methods are also disclosed. In this regard, in some exemplary aspects disclosed herein, a GPU based on a sliced GPU architecture includes multiple hardware slices that each comprise a slice primitive controller (PC_S) and multiple slice hardware units. The slice hardware units of each hardware slice include a geometry pipeline controller (GPC), a vertex shader (VS), a graphics rasterizer (GRAS), a low-resolution Z buffer (LRZ), a render backend (RB), a cache and compression unit (CCU), a graphics memory (GMEM), a high-level sequencer (HLSQ), a fragment shader/texture pipe (FS/TP), and a cluster cache (CCHE). In addition, the GPU further includes a command processor (CP) circuit and an unslice primitive controller (PC_US). Upon receiving a graphics instruction from a central processing unit (CPU), the CP circuit determines a graphics workload based on the graphics instruction and transmits the graphics workload to the PC_US. The PC_US then partitions the graphics workload into multiple subbatches and distributes each subbatch to a PC_S of a hardware slice for processing (e.g., based on a round-robin slice selection mechanism, and/or based on a current processing utilization of each hardware slice). By applying the sliced GPU architecture, a large GPU may be implemented as multiple hardware slices, with graphics workloads more efficiently subdivided among the multiple hardware slices. In this manner, the issues noted above with respect to physical design, clock frequency, design scalability, and workload imbalance may be effectively addressed.

Some aspects may further provide that each CCHE of each hardware slice may receive data from one or more clients (i.e., one or more of the plurality of slice hardware units) and may synchronize the one or more clients. A unified cache (UCHE) coupled to the CCHEs in such aspects also synchronizes the plurality of hardware slices. In some aspect, each LRZ of each hardware slice is configured to store cache lines corresponding only to pixel tiles that are assigned to the corresponding hardware slice. This may be accomplished by first mapping screen coordinates into a slice space that is continuous in coordinates and holds blocks for the hardware slice only, and then addressing tiles based on coordinates in the slice space.

According to some aspects, the hardware slices of the GPU perform additional operations to determine triangle visibility and assign triangle vertices to corresponding hardware slices. The GPU in such aspects further comprises an unslice vertex parameter cache (VPC_US), while each of the hardware slices further includes a corresponding slice Triangle Setup Engine front end (TSEFE_S), a slice vertex parameter cache front end (VPCFE_S), a slice vertex parameter cache back end (VPCBE_S), and a Triangle Setup Engine (TSE). Each VPCFE_S of each hardware slice may receive, from a corresponding VS of the hardware slice, primitive attribute and position outputs generated by the VS, and may write the primitive attribute and position outputs to the GMEM of the hardware slice. Each TSEFE_S of each corresponding hardware slice next determines triangle visibility for one or more hardware slices, based on the primitive attributes and position outputs. Each TSEFE_S then transmits one or more indications of triangle visibility for each of the one or more hardware slices to a VPC_US, which assigns triangles visible to each of the one or more hardware slices to the corresponding hardware slice based on the one or more indications of triangle visibility. Each VPCBE_S of each hardware slice identifies vertices for the triangles visible to the corresponding hardware slice, based on the triangles assigned by the VPC_US, and then transmits the vertices to a TSE of the corresponding hardware slice.

Some aspects of the GPU disclosed herein are further configured to provide a sliced LRZ that is external to and shared by the hardware slices of the GPU. In such aspects, each hardware slice of the GPU stores pixel tiles assigned to that hardware slice in an LRZ region corresponding exclusively to that hardware slice among a plurality of LRZ regions of the sliced LRZ, which is communicatively coupled to each hardware slice. In some aspects, storing the pixel tile may comprise the hardware slice mapping screen coordinates for the pixel tile into slice coordinates. The hardware slice next calculates an LRZ offset, an LRZ Y index, and an LRZ offset using the slice coordinates. The hardware slice then determines a block address for the pixel tiles within the sliced LRZ using the LRZ X index, the LRZ Y index, and a slice pitch for the LRZ region.

According to some aspects, the hardware slice may also update fast clear bits that correspond to the pixel tiles that are assigned to the hardware slice. The fast clear bits in such aspects are stored in a sliced LRZ fast clear buffer of the GPU. The sliced LRZ fast clear buffer is divided into a plurality of LRZ fast clear buffer regions that each corresponds to a hardware slice, and stores fast clear bits for pixel tiles assigned to that hardware slice. In some such aspects, the hardware slice may read from any of the plurality of LRZ fast clear buffer regions, but may write only to the LRZ fast clear buffer region corresponding to the hardware slice among the plurality of LRZ fast clear buffer regions.

Some aspects may further provide that the GPU provides a sliced LRZ metadata buffer comprising a plurality of LRZ metadata buffer regions that each correspond to a hardware slice, and metadata indicators (e.g., status bits and/or flags) for that hardware slice. In some such aspects, the hardware slice may read from and write to only the LRZ metadata buffer region corresponding to the hardware slice among the plurality of LRZ metadata buffer regions.

According to some aspects the GPU may determine whether the GPU is operating in a bin foveation mode. If so, the GPU is configured to fetch two or more pixel tiles from corresponding two or more hardware slices of the plurality of hardware slices, and perform a downsampling operation on the two or more pixel tiles to generate downsampled data. The GPU then stores the downsampled data in an LRZ region corresponding to the two or more pixel tiles among the plurality of LRZ regions.

In some such aspects, when operating in the bin foveation mode, the GPU may also retrieve LRZ metadata buffer data from each hardware slice of the plurality of hardware slices, and merges the LRZ metadata buffer data retrieved from each hardware slice of the plurality of hardware slices as merged LRZ metadata. The GPU then stores merged LRZ metadata in association with a hardware slice of the plurality of hardware slices. Some aspects may provide that the GPU also flushes an LRZ of each hardware slice of the plurality of hardware slices into the UCHE of the GPU.

In another aspect, a GPU is provided. The GPU comprises a plurality of hardware slices, and a sliced LRZ communicatively coupled to each hardware slice of the plurality of hardware slices and comprising a plurality of LRZ regions. Each hardware slice is configured to store, in an LRZ region corresponding exclusively to the hardware slice among the plurality of LRZ regions, a pixel tile assigned to the hardware slice.

In another aspect, a GPU is provided. The GPU comprises means for storing a pixel tile, assigned to a hardware slice of a plurality of hardware slices of the GPU, in an LRZ region corresponding exclusively to the hardware slice among a plurality of LRZ regions of a sliced LRZ communicatively coupled to each hardware slice of the plurality of hardware slices.

In another aspect, a method for operating a GPU comprising a plurality of hardware slices is provided. The method comprises storing, by a hardware slice of the plurality of hardware slices, a pixel tile assigned to the hardware slice in an LRZ region corresponding exclusively to the hardware slice among a plurality of LRZ regions of a sliced LRZ communicatively coupled to each hardware slice of the plurality of hardware slices.

In another aspect, a non-transitory computer-readable medium is disclosed, having stored thereon computer-executable instructions which, when executed by a processor device of a processor-based device, cause the processor device to store a pixel tile, assigned to a hardware slice of a plurality of hardware slices of a GPU of the processor-based device, in an LRZ region corresponding exclusively to the hardware slice among a plurality of LRZ regions of a sliced LRZ communicatively coupled to each hardware slice of the plurality of hardware slices.

### BRIEF DESCRIPTION OF THE FIGURES

FIG. 1 is a block diagram of an exemplary processor-based device including a graphics processing unit (GPU) based on a sliced GPU architecture;

FIGS. 2A and 2B are block diagrams illustrating the arrangement of contents of a low-resolution Z buffer (LRZ) caching pixel tiles in a conventional LRZ and in some aspects described herein, respectively;

FIGS. 3A-3C are flowcharts illustrating exemplary operations of the processor-based device and the GPU of FIG. 1 for receiving and subdividing a graphics workload among hardware slices, according to some aspects;

FIGS. 4A and 4B are flowcharts illustrating exemplary operations by hardware slices of the GPU of FIG. 1 for determining triangle visibility and assigning triangle vertices to corresponding hardware slices, according to some aspects;

FIG. 5 is a block diagram of an exemplary processor-based device including a GPU that provides a sliced LRZ that is external to and shared by hardware slices of the GPU, along with a sliced LRZ fast clear buffer and a sliced LRZ metadata buffer, according to some aspects;

FIG. 6 is a block diagram illustrating an exemplary internal arrangement for storing pixel tiles for each hardware slice of FIG. 5 within the sliced LRZ of FIG. 5, according to some aspects;

FIG. 7 is a block diagram illustrating a process for mapping screen space coordinates of pixel tiles into slice space coordinates, and further into a block address within the sliced LRZ of FIG. 5, according to some aspects;

FIG. 8 is a block diagram illustrating fast clear bit mapping within the sliced LRZ fast clear buffer of FIG. 5, according to some aspects;

FIG. 9 is a block diagram illustrating an exemplary internal layout of the sliced LRZ metadata buffer of FIG. 5, according to some aspects;

FIG. 10 is a block diagram illustrating the use of the sliced LRZ of FIG. 5 to store downsampled data when operating in a bin foveation mode, according to some aspects;

FIG. 11 is a block diagram illustrating metadata merging by the GPU of FIG. 5 when operating in a bin foveation mode, according to some aspects;

FIGS. 12A-12D are flowcharts illustrating exemplary operations of the GPU of FIG. 5 for providing a sliced LRZ, a sliced LRZ fast clear buffer, and a sliced LRZ metadata buffer, according to some aspects; and

FIG. 13 is a block diagram of an exemplary processor-based device that includes but is not limited to the processor-based device of FIGS. 1 and 5.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include a sliced graphics processing unit (GPU) architecture in processor-based devices. Related apparatus and methods are also disclosed. In this regard, in some exemplary aspects disclosed herein, a GPU based on a sliced GPU architecture includes multiple hardware slices that each comprise a slice primitive controller (PC_S) and multiple slice hardware units. The slice hardware units of each hardware slice include a geometry pipeline controller (GPC), a vertex shader (VS), a graphics rasterizer (GRAS), a low-resolution Z buffer (LRZ), a render backend (RB), a cache and compression unit (CCU), a graphics memory (GMEM), a high-level sequencer (HLSQ), a fragment shader/texture pipe (FS/TP), and a cluster cache (CCHE). In addition, the GPU further includes a command processor (CP) circuit and an unslice primitive controller (PC_US). Upon receiving a graphics instruction from a central processing unit (CPU), the CP circuit determines a graphics workload based on the graphics instruction and transmits the graphics workload to the PC_US. The PC_US then partitions the graphics workload into multiple subbatches and distributes each subbatch to a PC_S of a hardware slice for processing (e.g., based on a round-robin slice selection mechanism, and/or based on a current processing utilization of each hardware slice). By applying the sliced GPU architecture, a large GPU may be implemented as multiple hardware slices, with graphics workloads more efficiently subdivided among the multiple hardware slices. In this manner, the issues noted above with respect to physical design, clock frequency, design scalability, and workload imbalance may be effectively addressed.

Some aspects may further provide that each CCHE of each hardware slice may receive data from one or more clients (i.e., one or more of the plurality of slice hardware units) and may synchronize the one or more clients. A unified cache (UCHE) coupled to the CCHEs in such aspects also synchronizes the plurality of hardware slices. In some aspect, each LRZ of each hardware slice is configured to store cache lines corresponding only to pixel tiles that are assigned to the corresponding hardware slice. This may be accomplished by first mapping screen coordinates into a slice space that is continuous in coordinates and holds blocks for the hardware slice only, and then addressing tiles based on coordinates in the slice space.

According to some aspects, the hardware slices of the GPU perform additional operations to determine triangle visibility and assign triangle vertices to corresponding hardware slices. The GPU in such aspects further comprises an unslice vertex parameter cache (VPC_US), while each of the hardware slices further includes a corresponding slice Triangle Setup Engine front end (TSEFE_S), a slice vertex parameter cache front end (VPCFE_S), a slice vertex parameter cache back end (VPCBE_S), and a Triangle Setup Engine (TSE). Each VPCFE_S of each hardware slice may receive, from a corresponding VS of the hardware slice, primitive attribute and position outputs generated by the VS, and may write the primitive attribute and position outputs to the GMEM of the hardware slice. Each TSEFE_S of each corresponding hardware slice next determines triangle visibility for one or more hardware slices, based on the primitive attributes and position outputs. Each TSEFE_S then transmits one or more indications of triangle visibility for each of the one or more hardware slices to a VPC_US, which assigns triangles visible to each of the one or more hardware slices to the corresponding hardware slice based on the one or more indications of triangle visibility. Each VPCBE_S of each hardware slice identifies vertices for the triangles visible to the corresponding hardware slice, based on the triangles assigned by the VPC_US, and then transmits the vertices to a TSE of the corresponding hardware slice.

Some aspects of the GPU disclosed herein are further configured to provide a sliced LRZ that is external to and shared by the hardware slices of the GPU. In such aspects, each hardware slice of the GPU stores pixel tiles assigned to that hardware slice in an LRZ region corresponding exclusively to that hardware slice among a plurality of LRZ regions of the sliced LRZ, which is communicatively coupled to each hardware slice. In some aspects, storing the pixel tile may comprise the hardware slice mapping screen coordinates for the pixel tile into slice coordinates. The hardware slice next calculates an LRZ offset, an LRZ Y index, and an LRZ offset using the slice coordinates. The hardware slice then determines a block address for the pixel tiles within the sliced LRZ using the LRZ X index, the LRZ Y index, and a slice pitch for the LRZ region.

According to some aspects, the hardware slice may also update fast clear bits that correspond to the pixel tiles that are assigned to the hardware slice. The fast clear bits in such aspects are stored in a sliced LRZ fast clear buffer of the GPU. The sliced LRZ fast clear buffer is divided into a plurality of LRZ fast clear buffer regions that each corresponds to a hardware slice, and stores fast clear bits for pixel tiles assigned to that hardware slice. In some such aspects, the hardware slice may read from any of the plurality of LRZ fast clear buffer regions, but may write only to the LRZ fast clear buffer region corresponding to the hardware slice among the plurality of LRZ fast clear buffer regions.

Some aspects may further provide that the GPU provides a sliced LRZ metadata buffer comprising a plurality of LRZ metadata buffer regions that each correspond to a hardware slice, and metadata indicators (e.g., status bits and/or flags) for that hardware slice. In some such aspects, the hardware slice may read from and write to only the LRZ metadata buffer region corresponding to the hardware slice among the plurality of LRZ metadata buffer regions.

According to some aspects the GPU may determine whether the GPU is operating in a bin foveation mode. If so, the GPU is configured to fetch two or more pixel tiles from corresponding two or more hardware slices of the plurality of hardware slices, and perform a downsampling operation on the two or more pixel tiles to generate downsampled data. The GPU then stores the downsampled data in an LRZ region corresponding to the two or more pixel tiles among the plurality of LRZ regions.

In some such aspects, when operating in the bin foveation mode, the GPU may also retrieve LRZ metadata buffer data from each hardware slice of the plurality of hardware slices, and merges the LRZ metadata buffer data retrieved from each hardware slice of the plurality of hardware slices as merged LRZ metadata. The GPU then stores merged LRZ metadata in association with a hardware slice of the plurality of hardware slices. Some aspects may provide that the GPU also flushes an LRZ of each hardware slice of the plurality of hardware slices into the UCHE of the GPU.

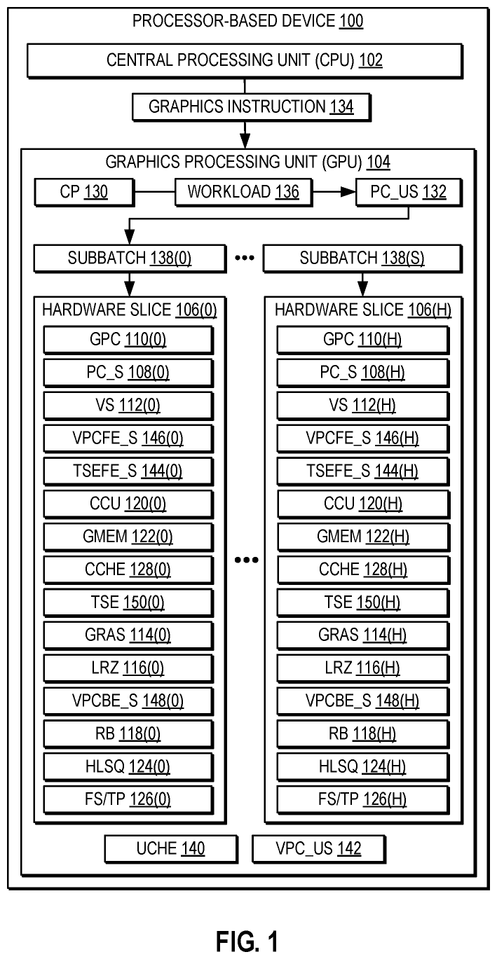

In this regard, FIG. 1 is a block diagram of an exemplary processor-based device 100. The processor-based device comprises a CPU 102, which also may be referred to herein as a “processor core” or a “CPU core,” may be an in-order or an out-of-order processor (OoP), and/or may be one of a plurality of CPUs 102 provided by the processor-based device 100. Examples of the CPU 102 may include, but are not limited to, a digital signal processor (DSP), general-purpose microprocessor, application specific integrated circuit (ASIC), field programmable logic array (FPGA), or other equivalent integrated or discrete logic circuitry. As seen in FIG. 1, the CPU 102 comprises a graphics processing unit (captioned as “GPU” in FIG. 1) 104, which comprises one or more dedicated processors for performing graphical operations. As a non-limiting example, the GPU 104 may comprise a dedicated hardware unit having fixed functionality and programmable components for rendering graphics and executing GPU applications. The GPU 104 may also include a DSP, a general-purpose microprocessor, an ASIC, an FPGA, or other equivalent integrated or discrete logic circuitry. Note that, while the CPU 102 and GPU 104 are illustrated as separate units in the example of FIG. 1, in some examples, the CPU 102 and GPU 104 may be integrated into a single unit. Although not shown in FIG. 1, it is to be understood that the CPU 102 of FIG. 1 may execute a software application or an Application Programming Interface (API) that submits, to the CPU, graphics instructions from which a graphics workload (comprising, e.g., multiple primitives) may be determined for processing by the GPU 104.

The processor-based device 100 of FIG. 1 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. It is to be understood that some aspects of the processor-based device 100 may include elements in addition to those illustrated in FIG. 1, and/or may include more or fewer of the elements illustrated in FIG. 1. For example, the processor-based device 100 may further include additional CPUs 102, processor cores, caches, controllers, communications buses, and/or persistent storage devices, which are omitted from FIG. 1 for the sake of clarity.

To address issues that may arise with respect to physical design, clock frequency, design scalability, and workload imbalance when increasing the physical size of the GPU 104, the GPU 104 in the example of FIG. 1 implements a sliced GPU architecture. Accordingly, the GPU 104 is configured to include multiple hardware slices 106(0)-106(H) that each provides a corresponding slice primitive controller (captioned as “PC_S” in FIG. 1) 108(0)-108(H) and multiple slice hardware units. As used herein, the phrase “slice hardware units” refers to elements of each hardware slice that provide functionality corresponding to conventional elements of a graphics pipeline of a GPU, and includes to GPCs 110(0)-110(H), VSs 112(0)-112(H), GRASs 114(0)-114(H), LRZs 116(0)-116(H), RB 118(0)-118(H), CCUs 120(0)-120(H), GMEMs 122(0)-122(H), HLSQs 124(0)-124(H), FS/TPs 126(0)-126(H), and CCHEs 128(0)-128(H). The GPU 104 further includes a CP circuit (captioned as “CP” in FIG. 1) 130 and a PC_US 132.

Each of the GPCs 110(0)-110(H) manages the manner in which vertices form the geometry of images to be rendered and are responsible for fetching vertices from memory and handling vertex data caches and vertices transformation. The VSs 112(0)-112(H) perform vertex transformation calculations, while each of the GRASS 114(0)-114(H) use information received from the GPCs 110(0)-110(H) to select vertices and build the triangles of which graphics images are composed. Each of the GRASs 114(0)-114(H) also converts the triangles into view port coordinates and remove triangles that are outside the view port (i.e., “back facing” triangles), and rasterizes each triangle to select pixels inside the triangle for later processing. The LRZs 116(0)-116(H) provide a mechanism for detecting if a block of pixels is completely hidden by other primitives that is faster but more conservative than calculating a detailed Z value for each pixel.

The RBs 118(0)-118(H) each performs detailed Z value checks and rejects pixels hidden by other pixels, and also takes the output from a pixel shader and performs final processing (e.g., blending, format conversion, and the like, as non-limiting examples) before sending to the data to a color buffer. The CCUs 120(0)-120(H) provide caches for depth and color data, and compress data before sending to system memory to save bandwidth. The GMEMs 122(0)-122(H) are used to buffer color and depth data in binning mode, and essentially serve as the Random Access Memory (RAM) of the corresponding CCUs 120(0)-120(H). Each HLSQs 124(0)-124(H) operates as a controller of a corresponding FS/TPs 126(0)-126(H), while each FS/TPs 126(0)-126(H) performs fragment shading (i.e., pixel shading) operations. The CCHEs 128(0)-128(H) provide a first-level cache between each FS/TPs 126(0)-126(H) and a UCHE 140.

In exemplary operation, the CPU 102 transmits a graphics instruction 134 to the CP circuit 130 of the GPU 104. The graphics instruction 134 represents a high-level instruction from an executing application or API requesting that a corresponding graphics operation be performed by the GPU 104 to generate an image or video. The graphics instruction 134 is received by the CP circuit 130 of the GPU 104 and is used to determine a graphics workload (captioned as “WORKLOAD” in FIG. 1) 136, which comprises a series of graphics primitives (not shown) that each represent a basic operation for generating and/or rendering an image. The CP circuit 130 transmits the graphics workload 136 to the PC_US 132, which partitions the graphics workload 136 into multiple subbatches 138(0)-138(S). The PC_US 132 then distributes each of the subbatches 138(0)-138(S) to a hardware slice of the hardware slices 106(0)-106(H) for processing in parallel. Some aspects may provide that a size of each of the subbatches 138(0)-138(S) (i.e., a number of primitives contained therein) is configurable. In some aspects, each of the subbatches 138(0)-138(S) may comprise 256 primitives (not shown).

In some aspects, the PC_US 132 may employ a round-robin slice selection mechanism to assign the subbatches 138(0)-138(S) to the hardware slices 106(0)-106(H). Some aspects may provide that the PC_US 132 may determine a current processing utilization of each of the hardware slices 106(0)-106(H), wherein each processing utilization indicates how much of the available processing resources of the corresponding hardware slice 106(0)-106(H) are currently in use. The PC_US 132 in such aspects may then assign the subbatches 138(0)-138(S) to the hardware slices 106(0)-106(H) based on the current processing utilization of the hardware slices 106(0)-106(H). For example, the PC_US 132 may assign subbatches only to hardware slices that have lower current processing utilization and thus more available processing resources.

In aspects according to FIG. 1, each CCHE 128(0)-128(H) of the hardware slices 106(0)-106(H) caches data for workloads processed by the slice hardware units of the corresponding hardware slices 106(0)-106(H) in a manner analogous to a Level 1 (L1) cache of a CPU. In the example of FIG. 1, the GPU 104 also provides a UCHE 140, analogous to a Level 2 (L2) cache of a CPU. The UCHE 140 is communicatively coupled to the CCHEs 128(0)-128(H) via a crossbar (not shown), and that caches data for all of the hardware slices 106(0)-106(H). Accordingly, in some aspects, each CCHE 128(0)-128(H) may receive data (not shown) from one or more clients (i.e., one or more of the slice hardware units of the corresponding hardware slices 106(0)-106(H)) and may synchronize the one or more clients. The UCHE 140 in such aspects also synchronizes the plurality of hardware slices 106(0)-106(H).

In some aspects, the hardware slices 106(0)-106(H) of the GPU 104 of FIG. 1 are configured to perform additional exemplary operations for determining triangle visibility and assigning triangle vertices to corresponding hardware slices. The GPU 104 in such aspects further comprises a VPC_US 142, while each of the hardware slices 106(0)-106(H) further includes a corresponding TSEFE_S 144(0)-144(H), a VPCFE_S 146(0)-146(H), a VPCBE_S 148(0)-148(H), and a TSE 150(0)-150(H). Each VPCFE_S 146(0)-146(H) receives, from a corresponding VS 112(0)-112(H), primitive attribute and position outputs (not shown) generated by the VS 112(0)-112(H). Each VPCFE_S 146(0)-146(H) writes the primitive attribute and position outputs to the GMEM 122(0)-122(H) of the corresponding hardware slice 106(0)-106(H). The primitive attribute and position outputs are then used by each TSEFE_S 144(0)-144(H) of the corresponding hardware slices 106(0)-106(H) to determine triangle visibility for each of one or more hardware slices of the hardware slices 106(0)-106(H). Each TSEFE_S 144(0)-144(H) then transmits a corresponding one or more indications of triangle visibility for each of the one or more hardware slices to the VPC_US 142. The VPC_US 142 uses the one or more indications of triangle visibility to assign triangles visible to each of the one or more hardware slices to the corresponding hardware slice. Each VPCBE_S 148(0)-148(H) of each hardware slice of the plurality of hardware slices 106(0)-106(H) identifies vertices for the triangles visible to the corresponding hardware slice, based on the triangles assigned by the VPC_US 142 of the corresponding hardware slice. Each VPCBE_S 148(0)-148(H) then transmits the vertices to the TSE 150(0)-150(H) of the corresponding hardware slice.

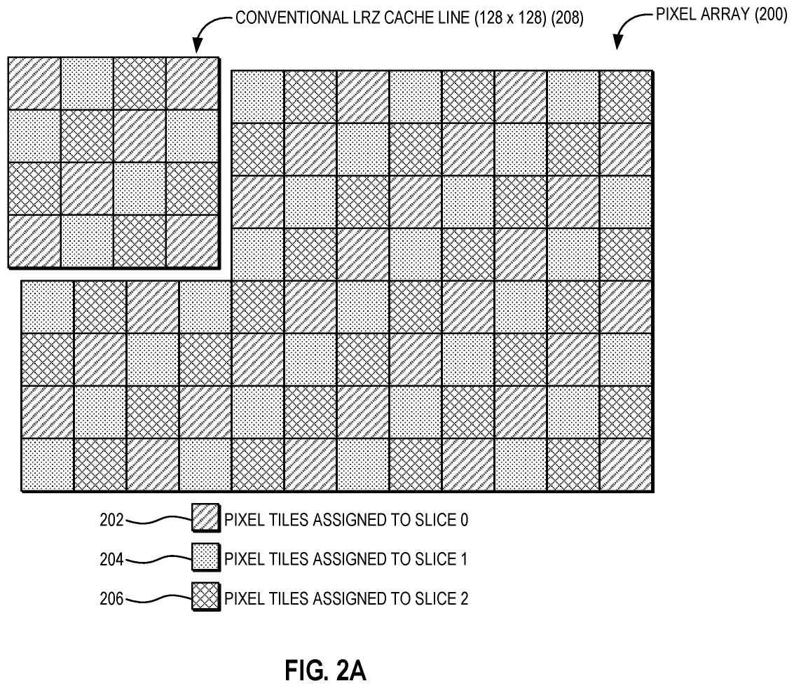

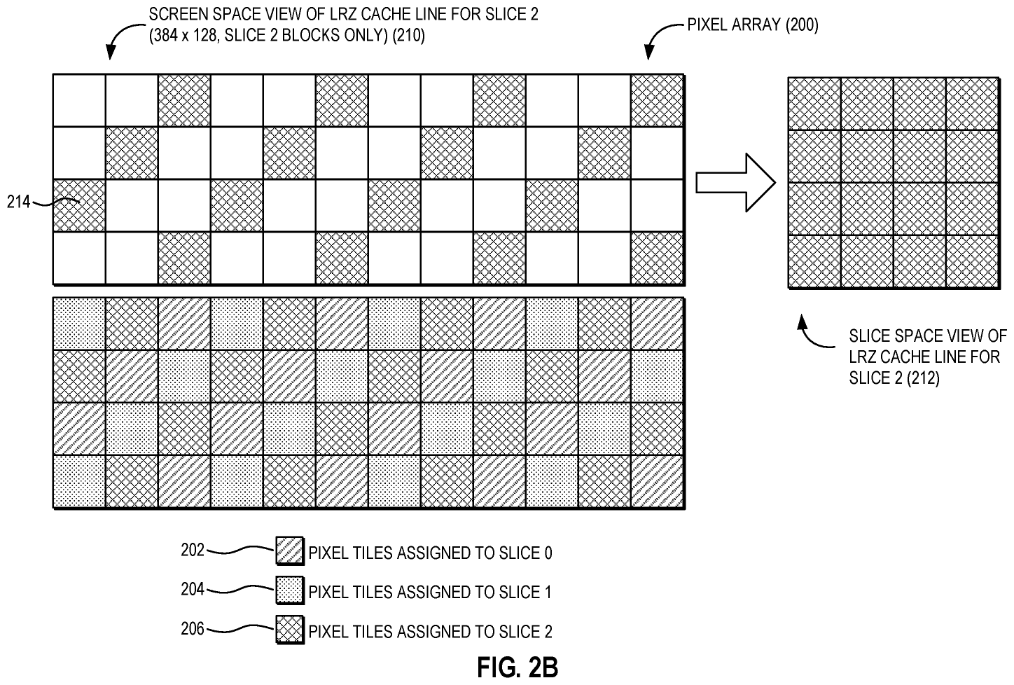

As noted above, the hardware slices 106(0)-106(H) of the GPU 104 provide corresponding LRZs 116(0)-116(H). In some aspects, the LRZs 116(0)-116(H) may be configured to store cache lines more efficiently relative to conventional LRZ. In this regard, FIGS. 2A and 2B illustrate cache line storage in conventional LRZs and in the LRZs 116(0)-116(H) of the GPU 104, respectively. As seen in FIG. 2A, a pixel array 200, representing pixels to be processed for display, is subdivided into pixel tiles, such as 32×32 pixel tiles assigned to a first pixel slice 0 as indicated by pattern 202, 32×32 pixel tiles assigned to a second pixel slice 1 as indicated by pattern 204, and 32×32 pixel tiles assigned to a third pixel slice 2 as indicated by pattern 206. As used herein, a “pixel slice” refers to the functional elements of each hardware slice 106(0)-106(H) that is responsible for pixel processing. A conventional LRZ provides a conventional LRZ cache line 208, which in this example covers 128×128 pixels, that stores pixel slices that are assigned to the pixel slice 0, the pixel slice 1, and the pixel slice 2. This results both in area wastage due to cache space not used for each slice, as well as coherency issues caused by an LRZ fast clear flag bit (not shown), which covers a 64×64 screen area and which may be read and/or written by multiple pixel slices.

Accordingly, in some aspects, each LRZ 116(0)-116(H) of each hardware slice 106(0)-106(H) of the GPU 104 is configured to store cache lines corresponding only to pixel tiles that are assigned to the corresponding hardware slice 106(0)-106(H). This may be accomplished by first mapping screen coordinates into a slice space that is continuous in coordinates and holds blocks for the hardware slice only, and then addressing tiles based on coordinates in the slice space. FIG. 2B illustrates an LRZ cache line in both a screen space view 210 and a slice space view 212 according to some aspects. As seen in the screen space view 210, the LRZ cache line covers 384×128 pixels of the pixel array 200, but only includes pixel tiles assigned to the pixel slice 2, such as the pixel tile 214. Thus, as seen in the slice space view 212, the LRZ cache line covers 128×128 pixels of the pixel tiles assigned to the pixel slice 2, thereby reducing space wastage and coherency issues associated with a conventional LRZ.

In some aspects, screen coordinates represented by integers x and y may be mapped into a slice space that is continuous in coordinates using the exemplary code shown in Table 1 below:

```
TABLE 1
switch(sliceNum) {
  case 1: lrzX = x; lrzY = y; break;
  case 2: lrzX = {lrzX[n:6], lrzX[4:0]}; lrzY = y; break;
  case 3: lrzX = {lrzX[n:5]/3, lrzX[4:0]}; lrzY = y; break;
  case 4: lrzX = {lrzX[n:6], lrzX[4:0]}; lrzY = {lrzY[n:6], lrzY[4:0]}; break;
  case 5: lrzX = {lrzX[n:5]/5, lrzX[4:0]}; lrzY = y; break;
  case 6: lrzX = {lrzX[n:5]/3, lrzX[4:0]}; lrzY = {lrzY[n:6], lrzY[4:0]}; break;
  case 7: lrzX = {lrzX[n:5]/5, lrzX[4:0]}; lrzY = y; break;
  case 8: lrzX = {lrzX[n:7], lrzX[4:0]}; lrzY = {lrzY[n:6], lrzY[4:0]}; break;
}
```

Inside each LRZ cache block, hardware is configured to address pixel tiles using conventional formula, but based on coordinates in the slice space, as shown by the exemplary code below in Table 2:

TABLE 2

```
Switch (MSAA) {
  Case 1xAA:
    yIndex = {lrzY[13:7],0,0,0,0}; // * pitch_in_byte
    xIndex = lrzX[13:8]; // *512 blocks/line * 2B/block
    offset
={lrzX[7],lrzY[6],lrzX[6],lrzY[5],lrzX[5],lrzY[4],lrzX[4],lrzY[3],lrzX[3]};
  case 2xAA: // 128x128−>128x64−>...8x8−>8x4
    yIndex = {lrzY[13:7],0,0,0,0,0}; // * pitch_in_byte
    xIndex = lrzX[13:7]; // *512 blocks/line * 2B/block
    offset =
{lrzY[6],lrzX[6],lrzY[5],lrzX[5],lrzY[4],lrzX[4],lrzY[3],lrzX[3],lrzY[2]};
  case 4xAA: // 128x64−>64x64−>...8x4−>4x4
    yIndex = {lrzY[13:6],0,0,0,0}; // * pitch_in_byte
    xIndex = {lrzX[13:7]; // *512 blocks * 2B/block
    offset =
{lrzX[6],lrzY[5],lrzX[5],lrzY[4],lrzX[4],lrzY[3],lrzX[3],lrzY[2],lrzX[2]};
  case 8xAA: // 64x64 −> 64x32 −> ... 4x4−> 4x2
    xIndex = lrzX[13:6]; // *512 blocks * 2B/block
    xIndex = lrzX[13:6]; // *512 blocks * 2B/block
    offset =
{lrzY[5],lrzX[5],lrzY[4],lrzX[4],lrzY[3],lrzX[3],lrzY[2],lrzX[2],lrzY[1]};
  }
```

Finally, when accessing an external LRZ, each pixel slice adds a slice pitch based on the total number of hardware slices 106(0)-106(H) in the GPU 104 to enable the system memory address to accommodate the LRZs 116(0)-116(H) for all the hardware slices 106(0)-106(H), as shown by the exemplary code below in table 3:

TABLE 3

```
BlockAddress (byte) = base + // base address in byte
  (rtai * array_pitch) + // array space in bytes
    (sliceID * slice_pitch) + // Slice space in bytes
      (yIndex * pitch) + // Pitch space in bytes
      (xIndex * 1KB) // cache block
```

The slice pitch in some aspects may be implemented as a new hardware register. Some aspects may provide that a graphics driver may allocate more LRZ space to account for alignment requirements for the slice pitch.

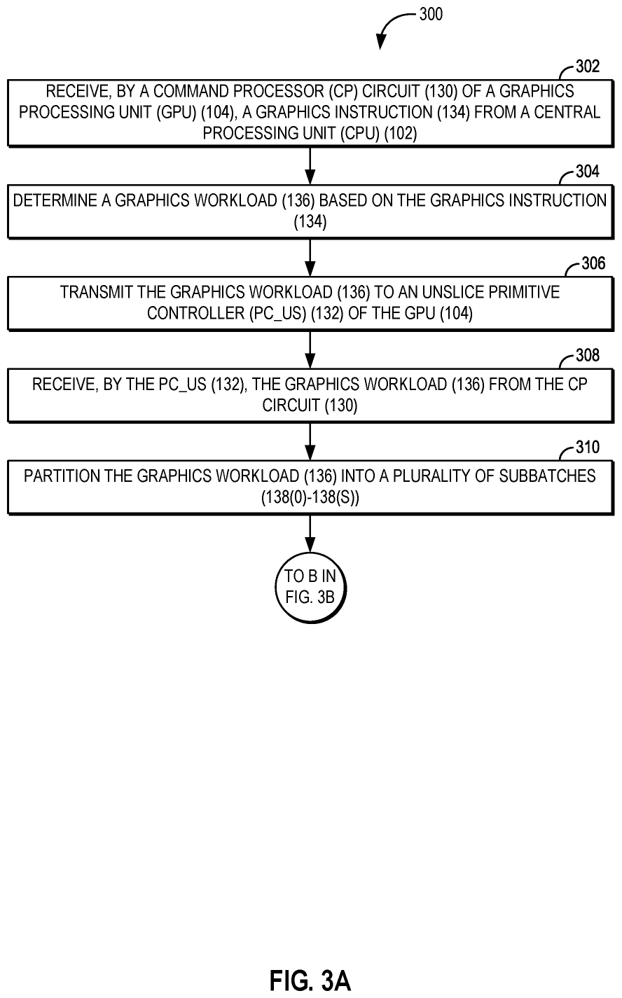

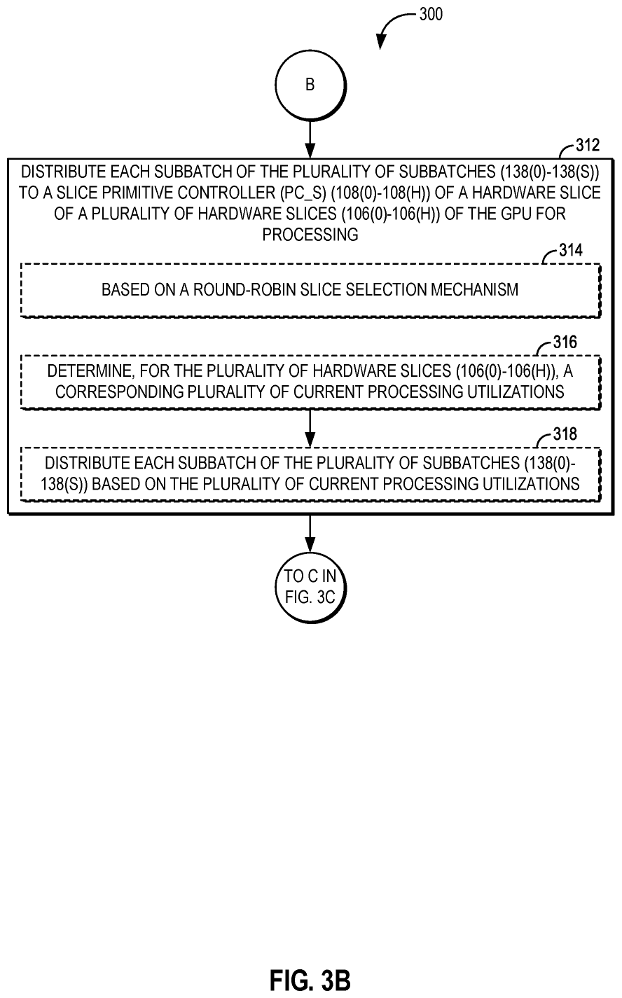

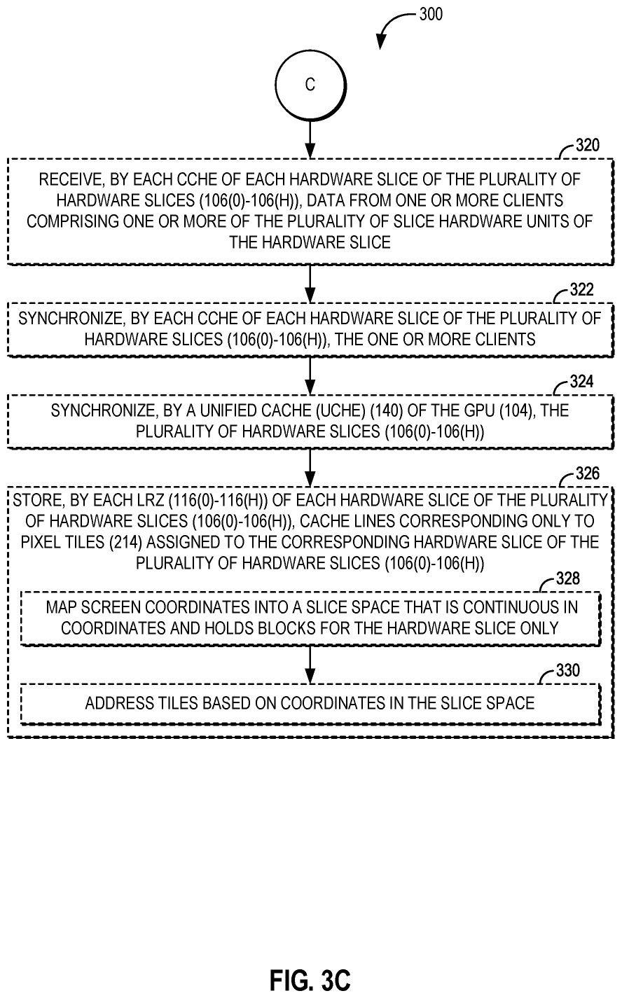

To further describe operations of the processor-based device 100 and the GPU 104 of FIG. 1 for receiving and subdividing a graphics workload among hardware slices, FIGS. 3A-3C provide a flowchart illustrating a process 300. For the sake of clarity, elements of FIGS. 1, 2A, and 2B are referenced in describing FIGS. 3A-3C. It is to be understood that some aspects may provide that some operations illustrated in FIGS. 3A-3C may be performed in an order other than that illustrated herein and/or may be omitted. In FIG. 3A, operations begin with a CP circuit of a GPU (e.g., the CP circuit 130 of the GPU 104 of FIG. 1) receiving a graphics instruction (e.g., the graphics instruction 134 of FIG. 1) from a CPU (e.g., the CPU 102 of FIG. 1) (block 302). The CP circuit 130 determines a graphics workload (e.g., the graphics workload 136 of FIG. 1) based on the graphics instruction 134 (block 304). The CP circuit 130 then transmits the graphics workload 136 to a PC_US (e.g., the PC_US 132 of FIG. 1) of the GPU 104 (block 306). The PC_US 132 receives the graphics workload 136 from the CP circuit 130 (block 308). The PC_US 132 then partitions the graphics workload 136 into a plurality of subbatches (e.g., the subbatches 138(0)-138(S) of FIG. 1) (block 310). Operations then continue at block 312 of FIG. 3B.

Referring now to FIG. 3B, the PC_US 132 next distributes each subbatch of the plurality of subbatches 138(0)-138(S) to a PC_S (e.g., the PC_S 108(0)-108(H) of FIG. 1) of a hardware slice of a plurality of hardware slices (e.g., the hardware slices 106(0)-106(H) of FIG. 1) of the GPU for processing, wherein each hardware slice of the plurality of hardware slices 106(0)-106(H) further comprises a plurality of slice hardware units (e.g., the slice hardware units of FIG. 1) (block 312). As seen in FIG. 1, the plurality of slice hardware units in some aspects may comprise the GPCs 110(0)-110(H), the VSs 112(0)-112(H), the GRASs 114(0)-114(H), the LRZs 116(0)-116(H), the RBs 118(0)-118(H), the CCUs 120(0)-120(H), the GMEMs 122(0)-122(H), the HLSQs 124(0)-124(H), the FS/TPs 126(0)-126(H), and the CCHEs 128(0)-128(H). In some aspects, the operations of block 312 for distributing each subbatch of the plurality of subbatches 138(0)-138(S) may be based on a round-robin slice selection mechanism (block 314). Some aspects may provide that the operations of block 312 for distributing each subbatch of the plurality of subbatches 138(0)-138(S) may comprise the PC_US 132 first determining, for the plurality of hardware slices 106(0)-106(H), a corresponding plurality of current processing utilizations (block 316). The PC_US 132 may then distribute each subbatch of the plurality of subbatches 138(0)-138(S) based on the plurality of current processing utilizations (block 318). Operations in some aspects may continue at block 320 of FIG. 3C.

Turning now to FIG. 3C, in some aspects, each CCHE 128(0)-128(H) of each hardware slice of the plurality of hardware slices 106(0)-106(H) receives data from one or more clients comprising one or more of the plurality of slice hardware units of the hardware slice (block 320). Each CCHE synchronizes the one or more clients (block 322). A UCHE (e.g., the UCHE 140 of FIG. 1) of the GPU 104 also synchronizes the plurality of hardware slices 106(0)-106(H) (block 324).

Some aspects may provide that each LRZ 116(0)-116(H) of each hardware slice of the plurality of hardware slices 106(0)-106(H) stores cache lines corresponding only to pixel tiles (e.g., the pixel tile 214 of FIG. 2B) assigned to the corresponding hardware slice of the plurality of hardware slices 106(0)-106(H) (block 326). According to some aspects, operations of block 326 for storing cache lines corresponding only to the pixel tiles assigned to the corresponding hardware slice of the plurality of hardware slices 106(0)-106(H) may comprise first mapping screen coordinates into a slice space that is continuous in coordinates and holds blocks for the hardware slice only (block 328). Each LRZ 116(0)-116(H) then addresses tiles based on coordinates in the slice space (block 330).

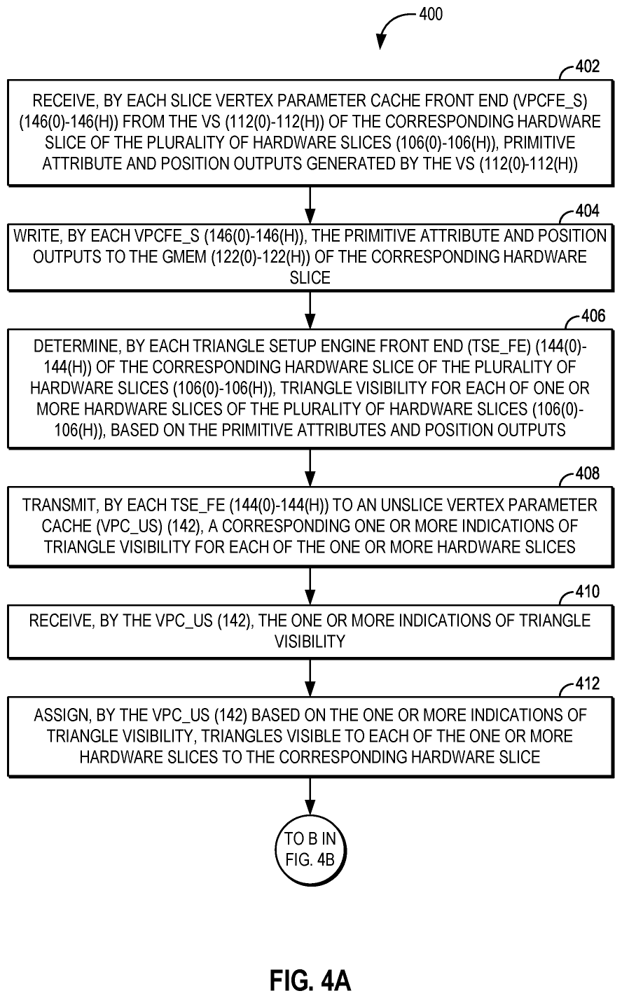

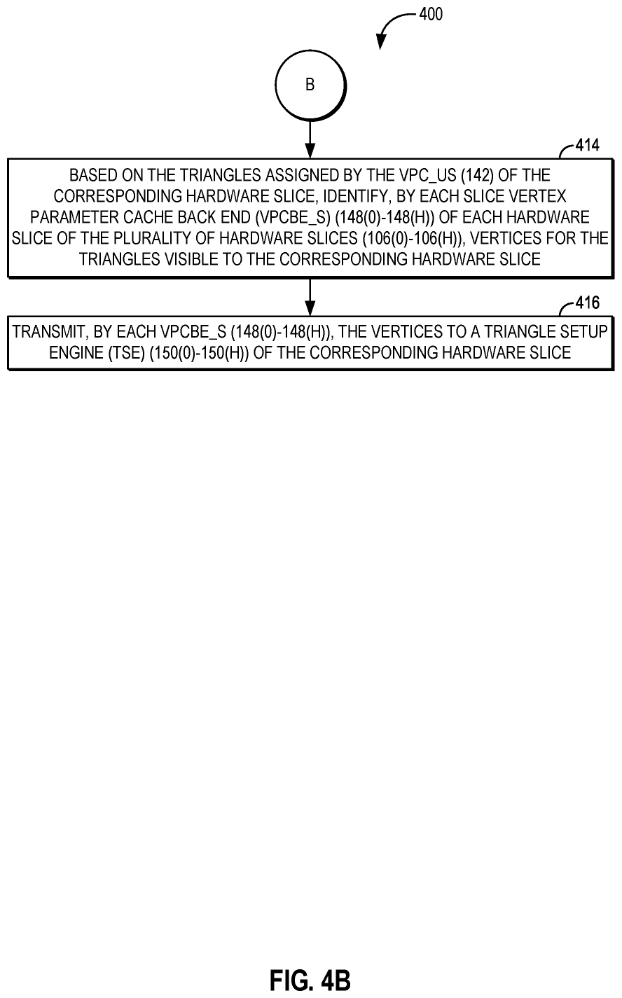

FIGS. 4A and 4B provide a flowchart illustrating an exemplary process 400 performed by hardware slices of the GPU 104 of FIG. 1 for determining triangle visibility and assigning triangle vertices to corresponding hardware slices, according to some aspects. Elements of FIG. 1 are referenced in describing FIGS. 4A and 4B for the sake of clarity. It is to be understood that, in some aspects, some operations illustrated in FIGS. 4A and 4B may be performed in an order other than that illustrated herein, or may be omitted.

Operations in FIG. 4A begin with each VPCFE_S 146(0)-146(H) of FIG. 1 receiving, from a corresponding VS such as the VS 112(0)-112(H) of the corresponding hardware slice of the plurality of hardware slices 106(0)-106(H), primitive attribute and position outputs generated by the VS 112(0)-112(H) (block 402). Each VPCFE_S 146(0)-146(H) writes the primitive attribute and position outputs to the GMEM 122(0)-122(H) of the corresponding hardware slice (block 404). Each TSEFE_S 144(0)-144(H) of the corresponding hardware slice of the plurality of hardware slices 106(0)-106(H) next determines triangle visibility for each of one or more hardware slices of the plurality of hardware slices 106(0)-106(H), based on the primitive attributes and position outputs (block 406). Each TSEFE_S 144(0)-144(H) then transmits, to a VPC_US such as the VPC_US 142 of FIG. 1, a corresponding one or more indications of triangle visibility for each of the one or more hardware slices (block 408).

The VPC_US 142 receives the one or more indications of triangle visibility (block 410). The VPC_US 142 then assigns, based on the one or more indications of triangle visibility, triangles visible to each of the one or more hardware slices to the corresponding hardware slice (block 412). Operations then continue at block 414 of FIG. 4B.

Referring now to FIG. 4B, each VPCBE_S 148(0)-148(H) of each hardware slice of the plurality of hardware slices 106(0)-106(H) identifies vertices for the triangles visible to the corresponding hardware slice, based on the triangles assigned by the VPC_US 142 of the corresponding hardware slice (block 414). Each VPCBE_S 148(0)-148(H) then transmits the vertices to a TSE 150(0)-150(H) of the corresponding hardware slice (block 416).

In sliced GPU architectures such as that implemented by the GPU 104 of FIG. 1, each hardware slice (e.g., the hardware slices 106(0)-106(H) of FIG. 1) includes its own LRZ (e.g., the LRZs 116(0)-116(H) of FIG. 1), and may also share a common LRZ fast clear buffer (not shown) and a common LRZ metadata buffer (not shown). The LRZ fast clear buffer in such aspects stores fast clear bits that indicate groups of pixels that are to be cleared, while the LRZ metadata buffer stores metadata indicators, such as status bits or flags, for each hardware slice. However, such a sliced GPU architecture may face a number of challenges. For example, the cache block granularity of each hardware slice's LRZ may be larger than the slice interleaving size (i.e., the size of each pixel tile of a screen that is processed by the hardware slice). For example, if the minimum cache block size is 128×32 pixels but the slice interleave size is 32×32 pixels, each entry within each hardware slice's LRZ may store data for four (4) pixel tiles. However, in aspects in which, e.g., three (3) hardware slices are working in parallel, each entry within each hardware slice's LRZ may store data for only one (1) or two (2) pixel tiles relevant to that hardware slice, with remaining space within the entry being used to store data for pixel tiles that are not processed by the hardware slice. This may result in each entry being only 25% or 50% utilized to store data relevant to that hardware slice. In addition, because LRZ fast clear bits within a common LRZ fast clear buffer are aligned to cache blocks, coherency issues may arise if multiple hardware slices read and/or update a same fast clear bit. Similar coherency issues may also arise with respect to a common LRZ metadata buffer (e.g., if multiple hardware slices read and/or update a metadata indicator within the LRZ metadata buffer).

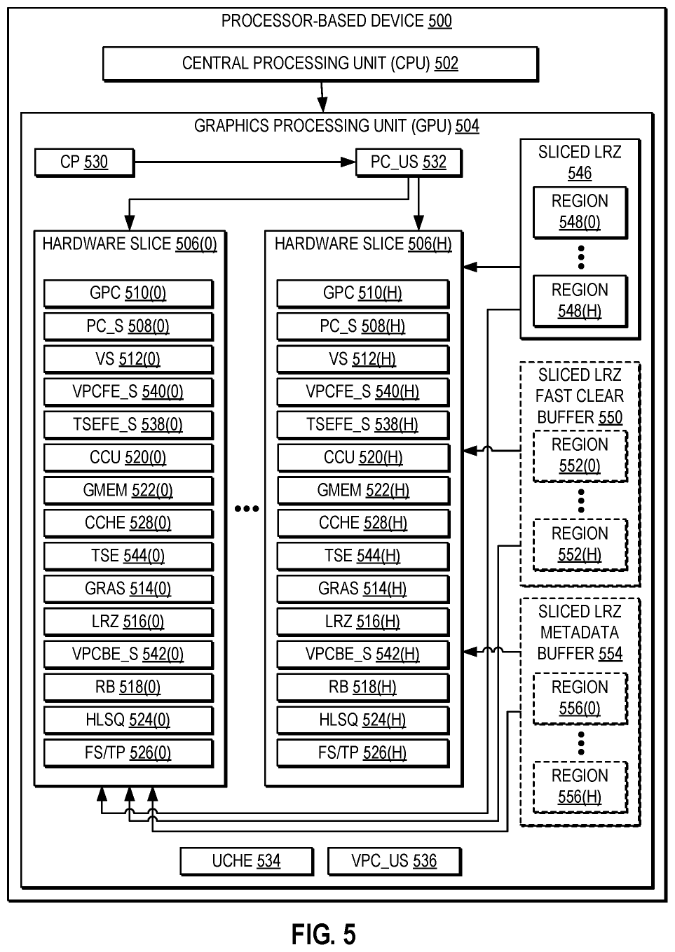

Accordingly, in this regard, FIG. 5 is a block diagram of an exemplary processor-based device 500 that comprises a CPU 502 and a GPU 504. The GPU 504 is configured to include multiple hardware slices 506(0)-506(H) that each provides a corresponding slice primitive controller (captioned as “PC_S” in FIG. 5) 508(0)-508(H) and multiple slice hardware units. The slice hardware units include GPCs 510(0)-510(H), VSs 512(0)-512(H), GRASs 514(0)-514(H), LRZs 516(0)-516(H), RB 518(0)-518(H), CCUs 520(0)-520(H), GMEMs 522(0)-522(H), HLSQs 524(0)-524(H), FS/TPs 526(0)-526(H), and CCHEs 528(0)-528(H). The GPU 504 further includes a CP circuit (captioned as “CP” in FIG. 5) 530 and a PC_US 532. The GPU 504 also provides a UCHE 534 that is communicatively coupled to the CCHEs 528(0)-528(H) via a crossbar (not shown), and that caches data for all of the hardware slices 506(0)-506(H). The GPU 504 of FIG. 5 additionally comprises a VPC_US 536, while each of the hardware slices 506(0)-506(H) further includes a corresponding TSEFE_S 538(0)-538(H), a VPCFE_S 540(0)-540(H), a VPCBE_S 542(0)-542(H), and a TSE 544(0)-544(H). It is to be understood that each of the elements of the GPU 504 of FIG. 5 corresponds in functionality to respective elements of the GPU 104 as described above with respect to FIG. 1.

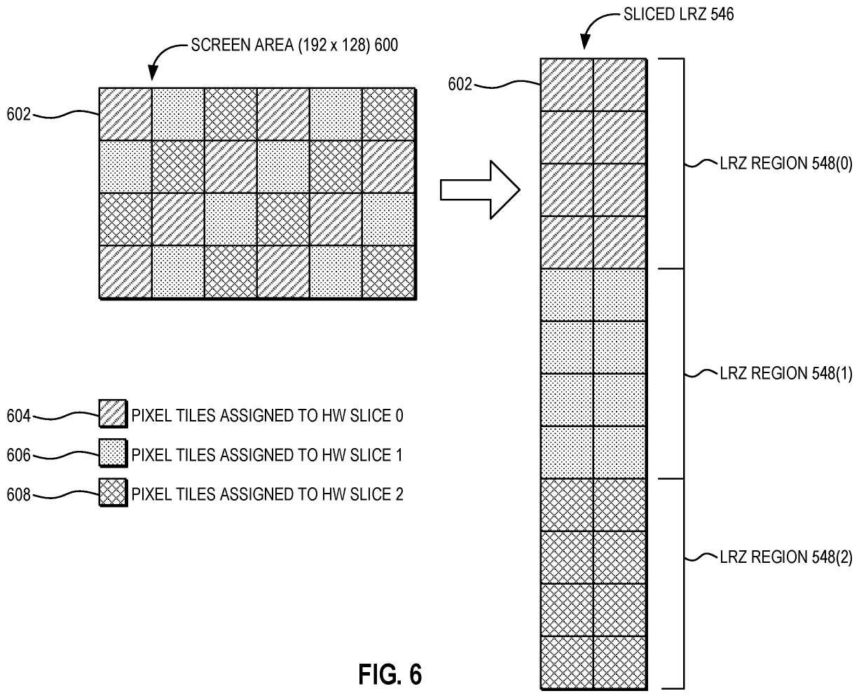

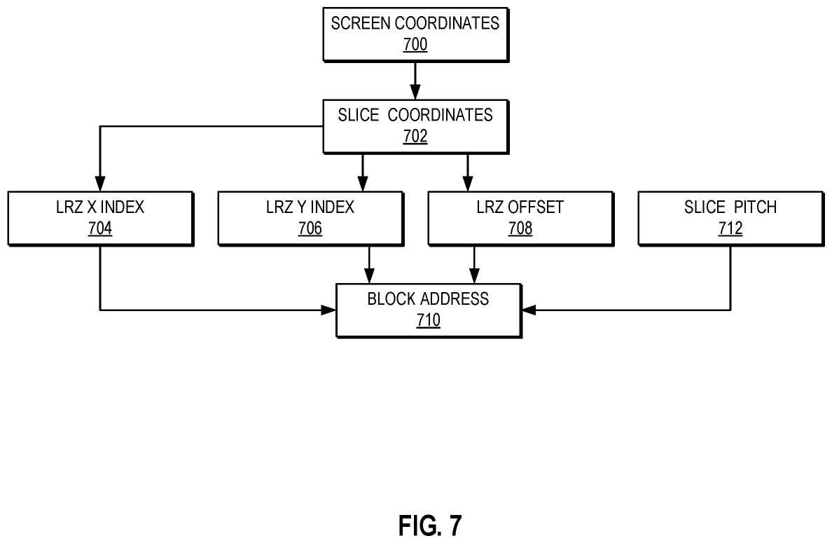

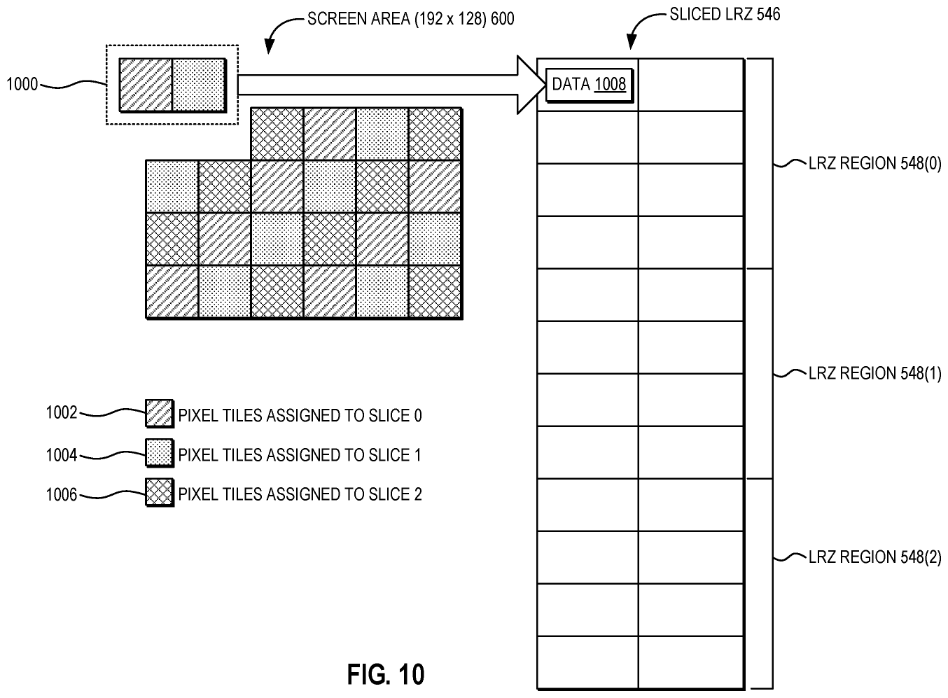

To enable more efficient use of LRZ storage space, the GPU 504 of FIG. 5 provides a sliced LRZ 546 that is communicatively coupled to each of the plurality of hardware slices 506(0)-506(H), and is subdivided into a plurality of LRZ regions (captioned as “REGION” in FIG. 5) 548(0)-548(H). Each of the LRZ regions 548(0)-548(H) corresponds exclusively to a respective hardware slice 506(0)-506(H). As discussed below in greater detail with respect to FIGS. 6 and 7, each of the hardware slices 506(0)-506(H) stores pixel tiles that are assigned to that hardware slice in the LRZ region 548(0)-548(H) corresponding to that hardware slice 506(0). FIG. 6 below illustrates how pixel tiles for each hardware slice may be stored internally within the sliced LRZ 546 in some aspects, while FIG. 7 illustrates an exemplary process for mapping screen space coordinates for each pixel tile into slice space coordinates, and further into a block address within the sliced LRZ 546. Special handling performed when the GPU 504 is operating in a bin foveation mode for performing downsampling of pixel tiles and storing the downsampled data is also discussed below in greater detail with respect to FIG. 10.

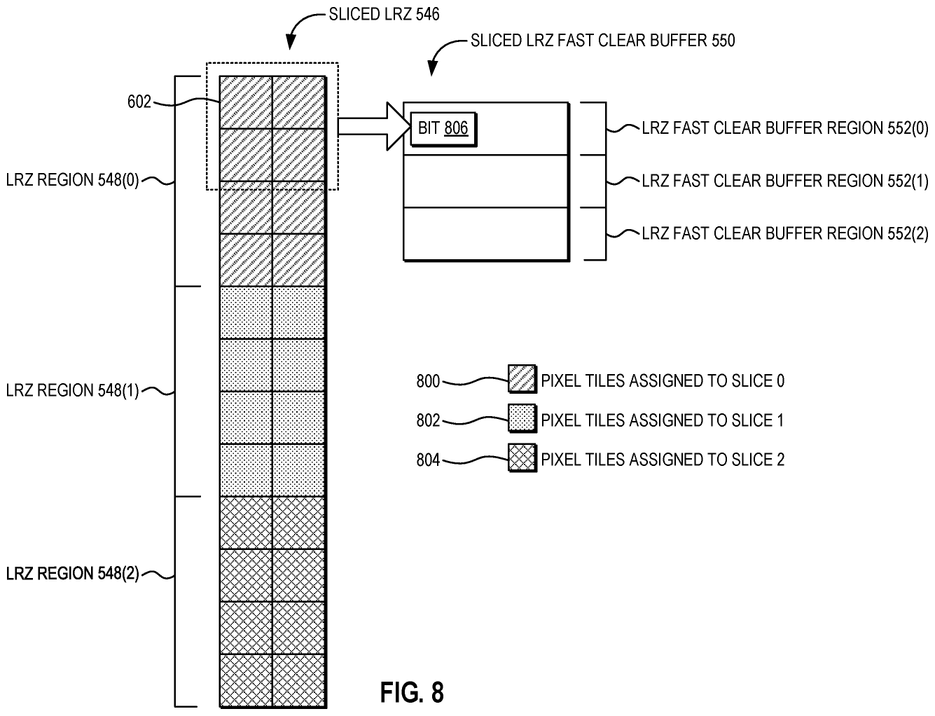

In some aspects, the GPU 504 of FIG. 5 further provides a sliced LRZ fast clear buffer 550 that is similarly subdivided into a plurality of LRZ fast clear buffer regions (captioned as “REGION” in FIG. 5) 552(0)-552(H) that correspond to respective hardware slices 506(0)-506(H). Each LRZ fast clear buffer region 552(0)-552(H) stores fast clear bits (not shown) that indicate whether to clear pixel tiles assigned to the corresponding hardware slice 506(0)-506(H). An exemplary internal layout of the sliced LRZ fast clear buffer 550 and exemplary formula for addressing fast clear bits stored therein are discussed in greater detail below with respect to FIG. 8. According to some aspects, each hardware slice 506(0)-506(H) can read from any of the plurality of LRZ fast clear buffer regions 552(0)-552(H), but can write only to the LRZ fast clear buffer region 552(0) corresponding to that hardware slice 506(0).

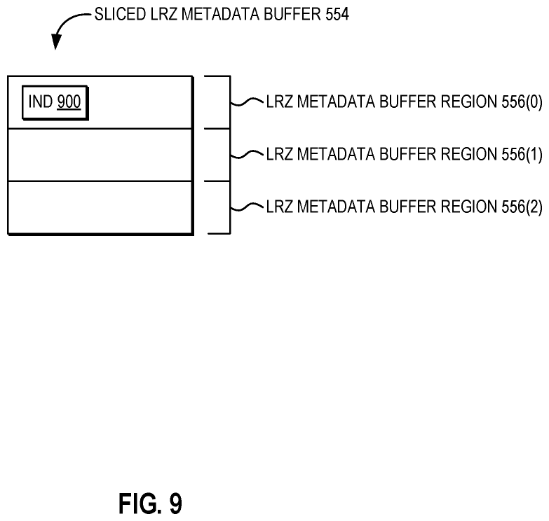

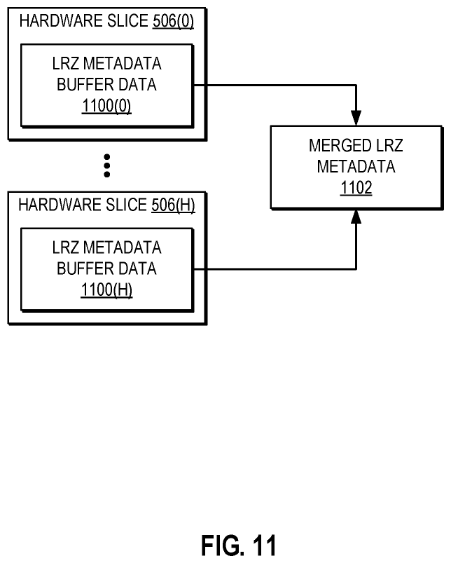

Some aspects further provide that the GPU 504 of FIG. 5 includes a sliced LRZ metadata buffer 554 subdivided into a plurality of LRZ metadata buffer regions 556(0)-556(H) corresponding to respective hardware slices 506(0)-506(H). The LRZ metadata buffer regions (captioned as “REGION” in FIG. 5) 556(0)-556(H) store metadata indicators, such as status bits or flags, for the corresponding hardware slices 506(0)-506(H). An exemplary internal layout of the sliced LRZ metadata buffer 554 is discussed in greater detail below with respect to FIG. 9. According to some aspects, each hardware slice 506(0)-506(H) can read from and write to only the LRZ metadata buffer region 556(0)-556(H) corresponding to that hardware slice 506(0)-506(H). Special handling for merging metadata when the GPU 504 is operating in a bin foveation mode is discussed below in greater detail with respect to FIG. 11.

FIG. 6 illustrates how pixel tiles for each of the hardware slices 506(0)-506(H) of FIG. 5 may be stored internally within the sliced LRZ 546 of FIG. 5, according to some aspects. In FIG. 6, a screen area 600 that is 192×128 pixels in area is subdivided into 32×32 pixel tiles, such as a pixel tile 602. These include 32×32 pixel tiles assigned to a first hardware slice 0 (e.g., the hardware slice 506(0)) as indicated by pattern 604, 32×32 pixel tiles assigned to a second hardware slice 1 (e.g., the hardware slice 506(1)) as indicated by pattern 606, and 32×32 pixel tiles assigned to a third hardware slice 2 (e.g., the hardware slice 506(2)) as indicated by pattern 608. The sliced LRZ 546 of FIG. 5 provides the LRZ regions 548(0)-548(2) (i.e., H=2 in this example) that each store pixel tiles that are assigned to the hardware slice 0, the hardware slice 1, and the hardware slice 2, respectively. In this example, each of the LRZ regions 548(0)-548(2) is 256 bytes in size, which provides coverage for a 64×128 sample area.

To address the sliced LRZ 546 based on screen coordinates of a given pixel tile, the screen coordinates are first mapped into slice space coordinates, and then further mapped into a block address within the sliced LRZ 546. FIG. 7 illustrates one exemplary process for performing the mapping operations. In exemplary operation, a hardware slice such as the hardware slice 506(0) of FIG. 5 may map screen coordinates 700 for a pixel tile (e.g., the pixel tile 602 of FIG. 6), into slice coordinates 702. This may be accomplished using the exemplary code shown in Table 4 below, where sliceNum is an integer indicating the number of hardware slices 506(0)-506(H) to which pixel tiles are assigned:

```
TABLE 4
switch(sliceNum) {
  case 1: slice.X = x; slice.Y = y; break;
  case 2: slice.X = {x[n:6], x[4:0]}; slice.Y = y; break; // XFac = 2, YFac = 1
  case 3: slice.X = {x[n:5]/3, x[4:0]}; slice.Y = y; break; // Xfac = 3, Yfac = 1
  case 4: slice.X = {x[n:6], x[4:0]}; slice.Y = {y[n:6], y[4:0]}; break;
  // Xfac=2, Yfac=2
  case 5: slice.X = {x[n:5]/5, x[4:0]}; slice.Y = y; break; // Xfac =5, Yfac=2
  case 6: slice.X = {x[n:5]/3, x[4:0]}; slice.Y = {y[n:6], y[4:0]}; break;
  // Xfac=3, Yfac=2
  case 7: slice.X = {x[n:5]/7, x[4:0]}; slice.Y = y; break; // Xfac=7, Yfac=1
  case 8: slice.X = {x[n:7], x[4:0]}; slice.Y = {y[n:6], y[4:0]}; break;
  // Xfac=4, Yfac=2
  case 16: slice.X = {x[n:7], x[4:0]}; slice.Y = {y[n:7], y[4:0]}; break;
  // Xfac=4, Yfac=4
  case32: slice.X = {x[n:8], x[4:0]}; slice.Y = {y[n:7], y[4:0]}; break;
  // Xfac=8, Yfac=4
}
```

The hardware slice 506(0) next calculates an LRZ X index 704, an LRZ Y index 706, and an LRZ offset 708 using the slice coordinates 702. The slice coordinates 702 may be calculated in some aspects using the exemplary code shown below in Table 5:

```
TABLE 5
Switch (MSAA) {
  Case 1xAA: // cacheline size: 64x128p, tile size: 8x8p
    yIndex = {slice.Y[13:7],0,0,0,0};
    xIndex = slice.X[13:6];
    offset ={slice.Y[6], slice.X[5], slice.Y[5], slice.Y[4], slice.X[4],
slice.Y[3], slice.X[3]};
  case 2xAA: // cacheline size: 64x64p, tile size: 8x4p
    yIndex = {slice.Y[13:6],0,0,0,0};
    xIndex = slice.X[13:6];
    offset = {slice.X[5], slice.Y[5], slice.Y[4], slice.X[4], slice.Y[3],
slice.X[3], slice.Y[2]};
  case 4xAA: // cacheline size: 32x64p, tile size: 4x4p
    yIndex = {slice.Y[13:6],0,0,0,0};
    xIndex = {slice.X[13:5];
    offset = {slice.Y[5], slice.Y[4], slice.X[4], slice.Y[3], slice.X[3],
slice.Y[2], slice.X[2]};
  case 8xAA: // cacheline size: 32x32p, tile size: 4x2p
    yIndex = {slice.Y[13:5],0,0,0,0};
    xIndex = slice.X[13:5];
    offset = {slice.Y[4], slice.X[4], slice.Y[3], slice.X[3], slice.Y[2],
slice.X[2], slice.Y[1]};
}
```

The hardware slice 506(0) then determines a block address 710 within the sliced LRZ 546 using the LRZ X index 704, the LRZ Y index 706, and a slice pitch 712 for the LRZ region 548(0). The slice pitch may be based on the total number of hardware slices 506(0)-506(H) in the GPU 504, and in some aspects may be implemented as a new hardware register. The block address 710 may be calculated in some aspects using the exemplary code shown below in Table 6:

```
TABLE 6
BlockAddress (byte) = base + // base address in byte
  (rtai * array_pitch) + // array space in bytes
  (sliceID * slice_pitch) + // Slice space in bytes
  (yIndex * pitch) + // Pitch space in bytes
  (xIndex * 256B) // cache line size = 256B
```

FIG. 8 is a block diagram illustrating fast clear bit mapping within the sliced LRZ fast clear buffer 550 of FIG. 5, according to some aspects. As seen in FIG. 8, the LRZ regions 548(0)-548(2) (i.e., H=2 in this example) of the sliced LRZ 546 of FIGS. 5 and 6 store pixel tiles (such as the pixel tile 602 of FIG. 6) that are assigned to the hardware slice 0, the hardware slice 1, and the hardware slice 2, respectively, as indicated by the corresponding patterns 800, 802, and 804. The sliced LRZ fast clear buffer 550 in the example of FIG. 8 is subdivided into LRZ fast clear buffer regions 552(0)-552(2) that correspond to the hardware slices 506(0)-506(2), and that store fast clear bits that indicate whether groups of one or more pixel tiles are to be cleared. Thus, as seen in FIG. 8, the hardware slice 506(0) may update a fast clear bit (captioned as “BIT” in FIG. 8) 806 that corresponds to a group of pixel tiles including the pixel tile 602 to indicate whether to clear the group of pixel tiles. In some such aspects, each of the hardware slices 506(0)-506(2) may read from any of the plurality of LRZ fast clear buffer regions 552(0)-552(2), but may write only to the LRZ fast clear buffer region 552(0)-552(2) corresponding to that hardware slice 506(0)-506(2) to prevent coherency issues.

In some aspects, fast clear bits within the sliced LRZ fast clear buffer 550 may be addressed using the exemplary code shown below in Table 7:

```
TABLE 7
// Each 256B LRZ buffer corresponding to 2 fast clear bits
// Must aligned to 256 bit to avoid overlapping between slices
FastClrSlicePitchInBits = align
(GRAS_LRZ_BUFFER_SLICE_PITCH.SlicePitchIn256B * 2, 256);
SliceStartInBits = FastClrSlicePitchInBits * sliceID;
// Align each RTAI to 512bit
FastClrRTAIPitchInBits = align (FastClrSlicePitchInBits * NumOfSlices, 512);
RTIStartInBits = FastClrRTAIPitchInBits * rtai;
FinalAddrInBits = FastClrBaseInBits + RTIStartInBits + SliceStartInBits +
  (yIndex * pitch >> 8 << 1) + // 2bit fast clear per 256B LRZ buffer
  (xIndex * 256 >> 8 << 1) + // 2 fast clear bits per 256B LRZ buffer
  Offset; // each bit covers 128B LRZ buffer
```

To illustrate a simplified exemplary internal layout of the sliced LRZ metadata buffer 554 of FIG. 5 according to some aspects, FIG. 9 is provided. As seen in FIG. 9, the sliced LRZ metadata buffer 554 is subdivided into the LRZ metadata buffer regions 556(0)-556(2) (i.e., H=2 in this example) that correspond to the hardware slices 506(0)-506(2) of FIG. 5. The LRZ metadata buffer regions 556(0)-556(2) may store metadata indicators, such as the metadata indicator (captioned as “IND” in FIG. 9) 900, that represent, e.g., a status bit or flag for the corresponding hardware slices 506(0)-506(2). Accordingly, for example, the hardware slice 506(0) may update a metadata indicator 900 of the LRZ metadata buffer region 556(0) corresponding to the hardware slice 506(0). In some such aspects, each of the hardware slices 506(0)-506(2) can read from and write to only the LRZ metadata buffer region 556(0) corresponding to that hardware slice 506(0) to avoid coherency issues.

When the GPU 504 is operating in a bin foveation mode, special handling is performed by the GPU 504 when using the sliced LRZ 546. In particular, each LRZ cache line in bin foveation mode is accessed in scaled domain and screen space, but not in slice space. Accordingly, the GPU 504 does not perform a conversion of screen coordinates to slice coordinates when allocating entries within the sliced LRZ 546 in bin foveation mode. Instead, the GPU 504 may fetch data from the LRZs 516(0)-516(H) of the hardware slices 506(0)-506(H) and perform downsampling, as shown in FIG. 10. As seen in FIG. 10, if the GPU 504 determines that the GPU 504 is operating in a bin foveation mode, the GPU 504 fetches two or more pixel tiles 1000 from corresponding two or more hardware slices of the plurality of hardware slices 506(0)-506(H), hardware slice 0, the hardware slice 1, and the hardware slice 2, respectively, as indicated by patterns 1002, 1004, and 1006. The GPU 504 performs a downsampling operation on the two or more pixel tiles 1000 to generate downsampled data (captioned as “DATA” in FIG. 10) 1008. The GPU 504 then stores the downsampled data 1008 in an LRZ region (e.g., the LRZ region 548(0), in this example) corresponding to the two or more pixel tiles 1000 among the plurality of LRZ regions 548(0)-548(2) (i.e., H=2 in this example).

In addition, when the GPU 504 is operating in the bin foveation mode, slice interleaving is done in scaled-with-offset domain rather than full resolution. Thus, in bin foveation mode, it may be possible for a primitive to be assigned to different hardware slices 506(0)-506(H) between the binning pass and the render pass. Consequently, the metadata for each hardware slice 506(0)-506(H) cannot be directly used in the render pass. Instead, as shown in FIG. 11, the GPU 504 retrieves LRZ metadata buffer data 1100(0)-1100(H) from each hardware slice of the plurality of hardware slices 506(0)-506(H), and merges the LRZ metadata buffer data 1100(0)-1100(H) as merged LRZ metadata 1102. The GPU 504 then stores merged LRZ metadata 1102 in association with a hardware slice (e.g., the hardware slice 506(0)) of the plurality of hardware slices 506(0)-506(H). Since slice interleaving may change between the binning pass and the foveated render pass, after the binning pass, the GPU 504 in some aspects flushes each LRZ 516(0)-516(H) of each hardware slice of the plurality of hardware slices 506(0)-506(H) into the UCHE 534 of the GPU 504.

In some aspects, merging of the LRZ metadata buffer data 1100(0)-1100(H) may be performed using the exemplary code shown below in Table 8:

```
TABLE 8
If (!status_cache_valid) {
  Fetch status buffer of ALL slices;
  If (Any diff of {statusBuffer.arrayStart,
                statusBuffer.arraySize,
                statusBuffer.mipLevel,
                statusCache.mipLevel,
                statusBuffer.fc_en,
                statusBuffer.fc_value,
                statusBuffer.BiDirEn} ) {
    statusCache.LRZstatus = 2'b11; // invalidate buffer on mismatches
  between slices
    ASSERT ERROR ! // assert
  }
  statusCache.LRZstatus |= statusBuffer.LRZstatus;
  statusCache.LRZWrDis |= statusBuffer.LRZWrDis;
  statusCache.forceBidirDis |= statusBuffer.forceBidirDis;
  statusCache.LRZcompMask |= statusBuffer.LRZCompMask;
  statusCache.dirty = 1;
}
```

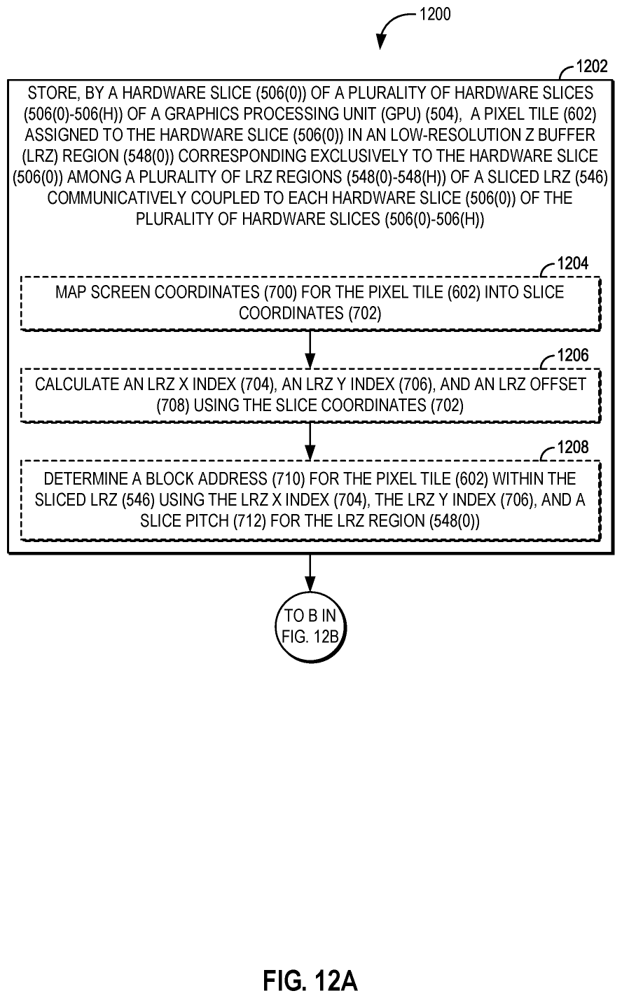

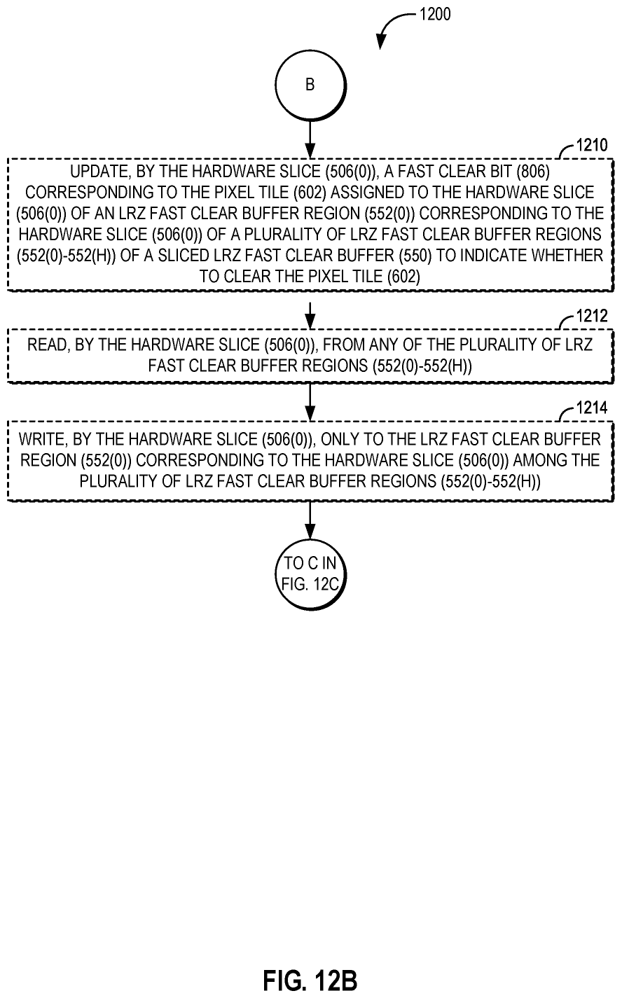

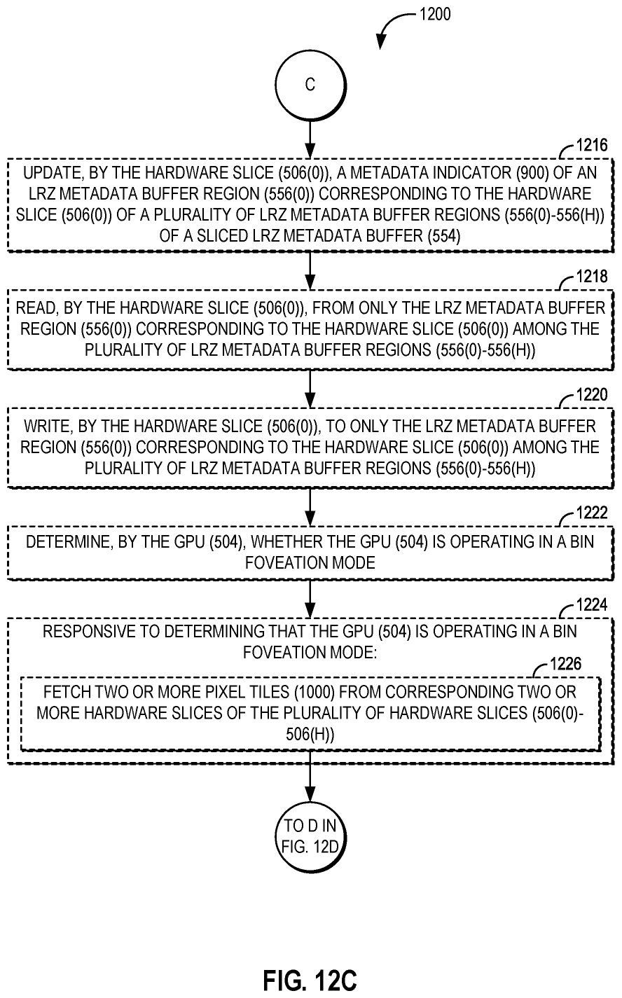

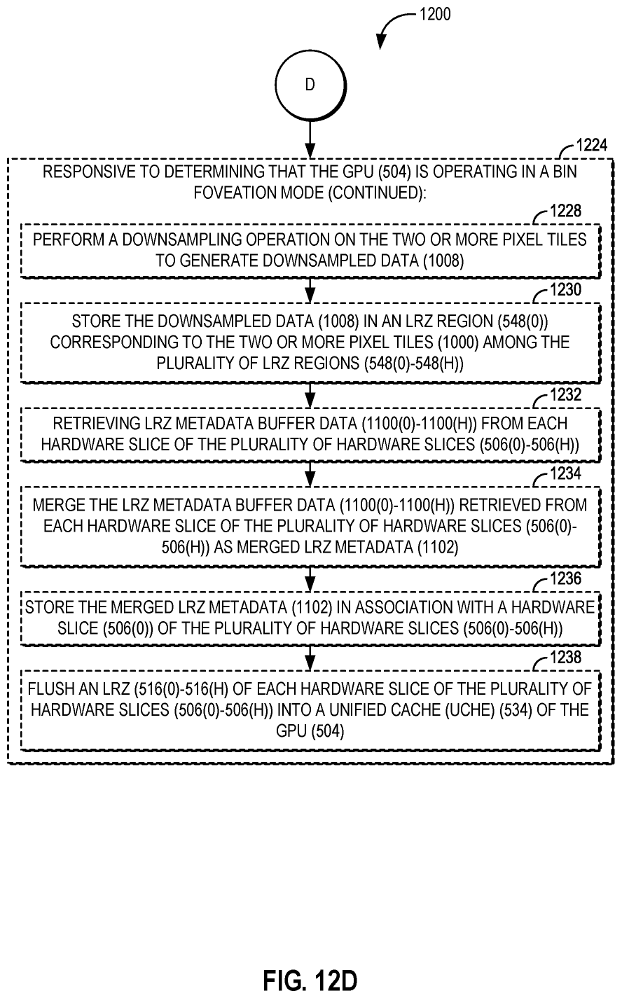

FIGS. 12A-12D illustrate exemplary operations 1200 for operating the GPU 504 of FIG. 5 using the sliced LRZ 546 of FIG. 5, according to some aspects. Elements of FIGS. 5-11 are referenced in describing FIGS. 12A-12D for the sake of clarity. It is to be understood that some of the exemplary operations 1200 may be performed in an order other than that illustrated in FIGS. 12A-12D in some aspects, and/or may be omitted in some aspects.

The exemplary operations 1200 begin in FIG. 12A with a hardware slice of a plurality of hardware slices of a GPU (e.g., the hardware slice 506(0) of the plurality of hardware slices 506(0)-506(H) of the GPU 504 of FIG. 5) storing a pixel tile (such as the pixel tile 602 of FIG. 6) assigned to the hardware slice 506(0) in an LRZ region (e.g., the LRZ region 548(0) of FIGS. 5 and 6) corresponding exclusively to the hardware slice 506(0) among a plurality of LRZ regions of a sliced LRZ (such as the LRZ regions 548(0)-548(H) of the sliced LRZ 546 of FIGS. 5 and 6) communicatively coupled to each hardware slice 506(0) of the plurality of hardware slices 506(0)-506(H) (block 1202). In some aspects, the operations of block 1202 for storing the pixel tile 602 may comprise the hardware slice 506(0) mapping screen coordinates (e.g., the screen coordinates 700 of FIG. 7) for the pixel tile 602 into slice coordinates (such as the slice coordinates 702 of FIG. 7) (block 1204). The hardware slice 506(0) next calculates an LRZ X index, an LRZ Y index, and an LRZ offset (e.g., the LRZ X index 704, the LRZ Y index 706, and the LRZ offset 708, respectively, of FIG. 7) using the slice coordinates 702 (block 1206). The hardware slice 506(0) then determines a block address (such as the block address 710 of FIG. 7) for the pixel tile 602 within the sliced LRZ 546 using the LRZ X index 704, the LRZ Y index 706, and a slice pitch (e.g., the slice pitch 712 of FIG. 7) for the LRZ region 548(0) (block 1208). The exemplary operations 1200 in some aspects continue at block 1210 of FIG. 12B.

Referring now to FIG. 12B, the exemplary operations 1200 according to some aspects continue with the hardware slice 506(0) updating a fast clear bit (such as the fast clear bit 806 of FIG. 8) corresponding to the pixel tile 602 assigned to the hardware slice 506(0) of an LRZ fast clear buffer region (e.g., the LRZ fast clear buffer region 552(0) of FIGS. 5 and 8) corresponding to the hardware slice 506(0) of a plurality of LRZ fast clear buffer regions of a sliced LRZ fast clear buffer (such as the LRZ fast clear buffer regions 552(0)-552(H) of the sliced LRZ fast clear buffer 550 of FIGS. 5 and 8) to indicate whether to clear the pixel tile 602 (block 1210). In some such aspects, the hardware slice 506(0) may read from any of the plurality of LRZ fast clear buffer regions 552(0)-552(H) (block 1212). The hardware slice 506(0) in such aspects may also write only to the LRZ fast clear buffer region 552(0) corresponding to the hardware slice 506(0) among the plurality of LRZ fast clear buffer regions 552(0)-552(H) (block 1214). The exemplary operations 1200 according to some aspects continue at block 1216 of FIG. 12C.

Turning now to FIG. 12C, some aspects may provide that the hardware slice 506(0) may update a metadata indicator (such as the metadata indicator 900 of FIG. 9) of an LRZ metadata buffer region (e.g., the LRZ metadata buffer region 556(0) of FIGS. 5 and 9) corresponding to the hardware slice 506(0) of a plurality of LRZ metadata buffer regions of a sliced LRZ metadata buffer (e.g., the LRZ metadata buffer regions 556(0)-556(H) of the sliced LRZ metadata buffer 554 of FIGS. 5 and 9 (block 1216). In some such aspects, the hardware slice 506(0) may read from only the LRZ metadata buffer region 556(0) corresponding to the hardware slice 506(0) among the plurality of LRZ metadata buffer regions 556(0)-556(H) (block 1218). Such aspects may further provide that the hardware slice 506(0) writes to only the LRZ metadata buffer region 556(0) corresponding to the hardware slice 506(0) among the plurality of LRZ metadata buffer regions 556(0)-556(H) (block 1220).

According to some aspects, the GPU 504 may determine whether the GPU 504 is operating in a bin foveation mode (block 1222). If so, the GPU 504 is configured to perform a series of operations (block 1224). The GPU 504 fetches two or more pixel tiles (such as the pixel tiles 1000 of FIG. 10) from corresponding two or more hardware slices of the plurality of hardware slices 506(0)-506(H) (block 1226). The exemplary operations 1200 in such aspects continue at block 1228 of FIG. 12D.

Referring now to FIG. 12D, the operations performed by the GPU 504 in response to determining that the GPU 504 in operating in a bin foveation mode continue (block 1224). The GPU 504 performs a downsampling operation on the two or more pixel tiles to generate downsampled data (such as the downsampled data 1008 of FIG. 10) (block 1228). The GPU 504 then stores the downsampled data 1008 in an LRZ region (e.g., the LRZ region 548(0) of FIGS. 5 and 10) corresponding to the two or more pixel tiles 1000 among the plurality of LRZ regions 548(0)-548(H) (block 1230).

In some such aspects, the GPU 504 may also retrieve LRZ metadata buffer data (e.g., the LRZ metadata buffer data 1100(0)-1100(H) of FIG. 11) from each hardware slice of the plurality of hardware slices 506(0)-506(H) (block 1232). The GPU 504 next merges the LRZ metadata buffer data 1100(0)-1100(H) retrieved from each hardware slice of the plurality of hardware slices 506(0)-506(H) as merged LRZ metadata (such as the merged LRZ metadata 1102 of FIG. 11) (block 1234). The GPU then stores merged LRZ metadata 1102 in association with the hardware slice 506(0) of the plurality of hardware slices 506(0)-506(H) (block 1236). Some aspects may provide that the GPU 504 flushes an LRZ (e.g., the LRZs 516(0)-516(H) of FIG. 5) of each hardware slice of the plurality of hardware slices 506(0)-506(H) into a UCHE) (e.g., the UCHE 534 of FIG. 5) of the GPU 504 (block 1238).

A GPU implemented according to the sliced GPU architecture as disclosed in aspects described herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

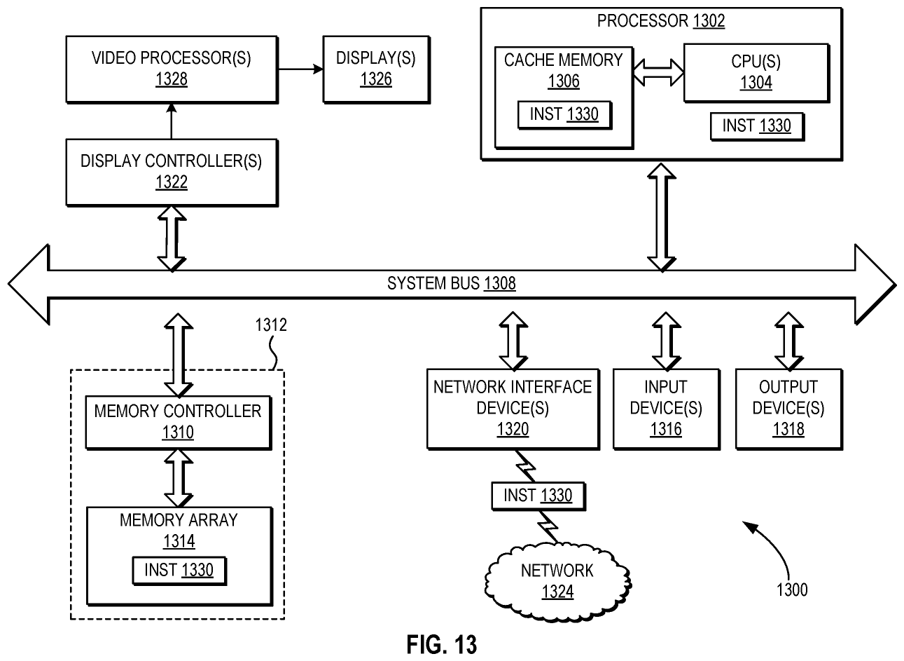

In this regard, FIG. 13 illustrates an example of a processor-based device 1300 that may comprise the processor-based device 100 illustrated in FIG. 1 or the processor-based device 500 of FIG. 5. In this example, the processor-based device 1300 includes a processor 1302 that includes one or more central processing units (captioned as “CPUs” in FIG. 13) 1304, which may comprise the CPU 102 of FIG. 1 or the CPU 502 of FIG. 5, and which may also be referred to as CPU cores or processor cores. The processor 1302 may have cache memory 1306 coupled to the processor 1302 for rapid access to temporarily stored data. The processor 1302 is coupled to a system bus 1308 and can intercouple master and slave devices included in the processor-based device 1300. As is well known, the processor 1302 communicates with these other devices by exchanging address, control, and data information over the system bus 1308. For example, the processor 1302 can communicate bus transaction requests to a memory controller 1310, as an example of a slave device. Although not illustrated in FIG. 13, multiple system buses 1308 could be provided, wherein each system bus 1308 constitutes a different fabric.

Other master and slave devices can be connected to the system bus 1308. As illustrated in FIG. 13, these devices can include a memory system 1312 that includes the memory controller 1310 and a memory array(s) 1314, one or more input devices 1316, one or more output devices 1318, one or more network interface devices 1320, and one or more display controllers 1322, as examples. The input device(s) 1316 can include any type of input device, including but not limited to input keys, switches, voice processors, etc. The output device(s) 1318 can include any type of output device, including, but not limited to, audio, video, other visual indicators, etc. The network interface device(s) 1320 can be any device configured to allow exchange of data to and from a network 1324. The network 1324 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 1320 can be configured to support any type of communications protocol desired.

The processor 1302 may also be configured to access the display controller(s) 1322 over the system bus 1308 to control information sent to one or more displays 1326. The display controller(s) 1322 sends information to the display(s) 1326 to be displayed via one or more video processors 1328, which process the information to be displayed into a format suitable for the display(s) 1326. The display controller(s) 1322 and/or the video processors 1328 may comprise or be integrated into a GPU such as the GPU 104 of FIG. 1. The display(s) 1326 can include any type of display, including but not limited to a cathode ray tube (CRT), a liquid crystal display (LCD), a plasma display, etc.

The processor-based device 1300 in FIG. 13 may include a set of instructions (captioned as “INST” in FIG. 13) 1330 that may be executed by the processor 1302 for any application desired according to the instructions. The instructions 1330 may be stored in the memory system 1312, the processor 1302, and/or the cache memory 1306, each of which may comprise an example of a non-transitory computer-readable medium. The instructions 1330 may also reside, completely or at least partially, within the memory system 1312 and/or within the processor 1302 during their execution. The instructions 1330 may further be transmitted or received over the network 1324, such that the network 1324 may comprise an example of a computer-readable medium.

While the computer-readable medium is described in an exemplary embodiment herein to be a single medium, the term “computer-readable medium” should be taken to include a single medium or multiple media (e.g., a centralized or distributed database, and/or associated caches and servers) that store the one or more sets of instructions 1330. The term “computer-readable medium” shall also be taken to include any medium that is capable of storing, encoding, or carrying a set of instructions for execution by a processing device and that cause the processing device to perform any one or more of the methodologies of the embodiments disclosed herein. The term “computer-readable medium” shall accordingly be taken to include, but not be limited to, solid-state memories, optical medium, and magnetic medium.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. A graphics processing unit (GPU) comprising:
   a plurality of hardware slices; and
   a sliced low-resolution Z buffer (LRZ) communicatively coupled to each hardware slice of the plurality of hardware slices and comprising a plurality of LRZ regions;
   wherein each hardware slice is configured to store, in an LRZ region corresponding exclusively to the hardware slice among the plurality of LRZ regions, a pixel tile assigned to the hardware slice.
2. The GPU of clause 1, wherein each hardware slice is configured to store the pixel tile assigned to the hardware slice by being configured to:
   map screen coordinates for the pixel tile into slice coordinates;
   calculate an LRZ X index, an LRZ Y index, and an LRZ offset using the slice coordinates; and
   determine a block address for the pixel tile within the sliced LRZ using the LRZ X index, the LRZ Y index, and a slice pitch for the LRZ region.
3. The GPU of any one of clauses 1-2, wherein:
   the GPU further comprises a sliced LRZ fast clear buffer communicatively coupled to each hardware slice of the plurality of hardware slices;
   the sliced LRZ fast clear buffer comprises a plurality of LRZ fast clear buffer regions each corresponding to a hardware slice of the plurality of hardware slices;
   each LRZ fast clear buffer region of the plurality of LRZ fast clear buffer regions comprises a fast clear bit corresponding to the pixel tile assigned to the hardware slice; and
   each hardware slice of the plurality of hardware slices is further configured to update the fast clear bit corresponding to the pixel tile assigned to the hardware slice to indicate whether to clear the pixel tile.
4. The GPU of clause 3, wherein each hardware slice of the plurality of hardware slices is further configured to:
   read from any of the plurality of LRZ fast clear buffer regions; and
   write only to the LRZ fast clear buffer region corresponding to the hardware slice among the plurality of LRZ fast clear buffer regions.
5. The GPU of any one of clauses 1-4, wherein:
   the GPU further comprises a sliced LRZ metadata buffer communicatively coupled to each hardware slice of the plurality of hardware slices;
   the sliced LRZ metadata buffer comprises a plurality of LRZ metadata buffer regions each corresponding to a hardware slice of the plurality of hardware slices;
   each LRZ metadata buffer region of the plurality of LRZ metadata buffer regions comprises a metadata indicator; and
   each hardware slice of the plurality of hardware slices is further configured to update the metadata indicator of the LRZ metadata buffer region corresponding to the hardware slice.
6. The GPU of clause 5, wherein each hardware slice of the plurality of hardware slices is further configured to:
   read from only the LRZ metadata buffer region corresponding to the hardware slice among the plurality of LRZ metadata buffer regions; and
   write to only the LRZ metadata buffer region corresponding to the hardware slice among the plurality of LRZ metadata buffer regions.
7. The GPU of any one of clauses 1-6, further configured to:
   determine whether the GPU is operating in a bin foveation mode; and
   responsive to determining that the GPU is operating in a bin foveation mode:
      fetch two or more pixel tiles from corresponding two or more hardware slices of the plurality of hardware slices;
      perform a downsampling operation on the two or more pixel tiles to generate downsampled data; and
      store the downsampled data in an LRZ region corresponding to the two or more pixel tiles among the plurality of LRZ regions.
8. The GPU of clause 7, further configured to, responsive to determining that the GPU is operating in a bin foveation mode:
   retrieve LRZ metadata buffer data from each hardware slice of the plurality of hardware slices;
   merge the LRZ metadata buffer data retrieved from each hardware slice of the plurality of hardware slices as merged LRZ metadata; and
   store the merged LRZ metadata in association with a hardware slice of the plurality of hardware slices.
9. The GPU of any one of clauses 7-8, wherein:
   the GPU further comprises a unified cache (UCHE) communicatively coupled to each hardware slice of the plurality of hardware slices; and
   the GPU is further configured to, responsive to determining that the GPU is operating in a bin foveation mode, flush an LRZ of each hardware slice of the plurality of hardware slices into the UCHE.
10. The GPU of any one of clauses 1-9, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
11. A graphics processing unit (GPU), comprising means for storing a pixel tile, assigned to a hardware slice of a plurality of hardware slices of the GPU, in a low-resolution Z buffer (LRZ) region corresponding exclusively to the hardware slice among a plurality of LRZ regions of a sliced LRZ communicatively coupled to each hardware slice of the plurality of hardware slices.
12. A method for operating a graphics processing unit (GPU) comprising a plurality of hardware slices, comprising storing, by a hardware slice of the plurality of hardware slices, a pixel tile assigned to the hardware slice in a low-resolution Z buffer (LRZ) region corresponding exclusively to the hardware slice among a plurality of LRZ regions of a sliced LRZ communicatively coupled to each hardware slice of the plurality of hardware slices.
13. The method of clause 12, wherein storing the pixel tile assigned to the hardware slice comprises:
   mapping screen coordinates for the pixel tile into slice coordinates;
   calculating an LRZ X index, an LRZ Y index, and an LRZ offset using the slice coordinates; and
   determining a block address for the pixel tile within the sliced LRZ using the LRZ X index, the LRZ Y index, and a slice pitch for the LRZ region.
14. The method of any one of clauses 12-13, wherein:
   the GPU further comprises a sliced LRZ fast clear buffer communicatively coupled to each hardware slice of the plurality of hardware slices;
   the sliced LRZ fast clear buffer comprises a plurality of LRZ fast clear buffer regions each corresponding to a hardware slice of the plurality of hardware slices;
   each LRZ fast clear buffer region of the plurality of LRZ fast clear buffer regions comprises a fast clear bit corresponding to the pixel tile assigned to the hardware slice; and the method further comprises updating, by the hardware slice, the fast clear bit corresponding to the pixel tile assigned to the hardware slice to indicate whether to clear the pixel tile.
15. The method of clause 14, further comprising:
   reading, by the hardware slice, from any of the plurality of LRZ fast clear buffer regions; and
   writing, by the hardware slice, only to the LRZ fast clear buffer region corresponding to the hardware slice among the plurality of LRZ fast clear buffer regions.
16. The method of any one of clauses 12-15, wherein:
   the GPU further comprises a sliced LRZ metadata buffer communicatively coupled to each hardware slice of the plurality of hardware slices;
   the sliced LRZ metadata buffer comprises a plurality of LRZ metadata buffer regions each corresponding to a hardware slice of the plurality of hardware slices;
   each LRZ metadata buffer region of the plurality of LRZ metadata buffer regions comprises a metadata indicator; and
   the method further comprises updating the metadata indicator of the LRZ metadata buffer region corresponding to the hardware slice.
17. The method of clause 16, further comprising:
   reading, by the hardware slice, from only the LRZ metadata buffer region corresponding to the hardware slice among the plurality of LRZ metadata buffer regions; and
   writing, by the hardware slice, to only the LRZ metadata buffer region corresponding to the hardware slice among the plurality of LRZ metadata buffer regions.
18. The method of any one of clauses 12-17, further comprising:
   determining, by the GPU, that the GPU is operating in a bin foveation mode; and
   responsive to determining that the GPU is operating in a bin foveation mode:
      fetching two or more pixel tiles from corresponding two or more hardware slices of the plurality of hardware slices;
      performing a downsampling operation on the two or more pixel tiles to generate downsampled data; and
      storing the downsampled data in an LRZ region corresponding to the two or more pixel tiles among the plurality of LRZ regions.
19. The method of clause 18, further comprising, responsive to determining that the GPU is operating in a bin foveation mode:
   retrieving LRZ metadata buffer data from each hardware slice of the plurality of hardware slices;
   merging the LRZ metadata buffer data retrieved from each hardware slice of the plurality of hardware slices as merged LRZ metadata; and
   storing the merged LRZ metadata in association with a hardware slice of the plurality of hardware slices.
20. The method of any one of clauses 18-19, wherein:
   the GPU further comprises a unified cache (UCHE) communicatively coupled to each hardware slice of the plurality of hardware slices; and
   the method further comprises, responsive to determining that the GPU is operating in a bin foveation mode, flushing an LRZ of each hardware slice of the plurality of hardware slices into the UCHE.
21. A non-transitory computer-readable medium having stored thereon computer-executable instructions which, when executed by a processor device of a processor-based device, cause the processor device to store a pixel tile, assigned to a hardware slice of a plurality of hardware slices of a graphics processing unit (GPU) of the processor-based device, in a low-resolution Z buffer (LRZ) region corresponding exclusively to the hardware slice among a plurality of LRZ regions of a sliced LRZ communicatively coupled to each hardware slice of the plurality of hardware slices.
22. The non-transitory computer-readable medium of clause 21, wherein the computer-executable instructions cause the processor device to store the pixel tile assigned to the hardware slice by causing the processor device to:
   map screen coordinates for the pixel tile into slice coordinates;
   calculate an LRZ X index, an LRZ Y index, and an LRZ offset using the slice coordinates; and
   determine a block address for the pixel tile within the sliced LRZ using the LRZ X index, the LRZ Y index, and a slice pitch for the LRZ region.
23. The non-transitory computer-readable medium of any one of clauses 21-22, wherein:
   the GPU further comprises a sliced LRZ fast clear buffer communicatively coupled to each hardware slice of the plurality of hardware slices;
   the sliced LRZ fast clear buffer comprises a plurality of LRZ fast clear buffer regions each corresponding to a hardware slice of the plurality of hardware slices;
   each LRZ fast clear buffer region of the plurality of LRZ fast clear buffer regions comprises a fast clear bit corresponding to the pixel tile assigned to the hardware slice; and
   the computer-executable instructions further cause the processor device to update the fast clear bit corresponding to the pixel tile assigned to the hardware slice to indicate whether to clear the pixel tile.
24. The non-transitory computer-readable medium of clause 23, wherein the computer-executable instructions further cause the processor device to:
   read from any of the plurality of LRZ fast clear buffer regions; and
   write only to the LRZ fast clear buffer region corresponding to the hardware slice among the plurality of LRZ fast clear buffer regions.
25. The non-transitory computer-readable medium of any one of clauses 21-24, wherein:
   the GPU further comprises a sliced LRZ metadata buffer communicatively coupled to each hardware slice of the plurality of hardware slices;
   the sliced LRZ metadata buffer comprises a plurality of LRZ metadata buffer regions each corresponding to a hardware slice of the plurality of hardware slices;
   each LRZ metadata buffer region of the plurality of LRZ metadata buffer regions comprises a metadata indicator; and
   the computer-executable instructions further cause the processor device to update the metadata indicator of the LRZ metadata buffer region corresponding to the hardware slice.
26 The non-transitory computer-readable medium of clause 25, wherein the computer-executable instructions further cause the processor device to:
   read from only the LRZ metadata buffer region corresponding to the hardware slice among the plurality of LRZ metadata buffer regions; and
   write to only the LRZ metadata buffer region corresponding to the hardware slice among the plurality of LRZ metadata buffer regions.
27. The non-transitory computer-readable medium of any one of clauses 21-26, wherein the computer-executable instructions further cause the processor device to:
   determine whether the GPU is operating in a bin foveation mode; and
   responsive to determining that the GPU is operating in a bin foveation mode:
      fetch two or more pixel tiles from corresponding two or more hardware slices of the plurality of hardware slices;
      perform a downsampling operation on the two or more pixel tiles to generate downsampled data; and
      store the downsampled data in an LRZ region corresponding to the two or more pixel tiles among the plurality of LRZ regions.
28. The non-transitory computer-readable medium of clause 27, wherein the computer-executable instructions further cause the processor device to, responsive to determining that the GPU is operating in a bin foveation mode:
   retrieve LRZ metadata buffer data from each hardware slice of the plurality of hardware slices;
   merge the LRZ metadata buffer data retrieved from each hardware slice of the plurality of hardware slices as merged LRZ metadata; and
   store the merged LRZ metadata in association with a hardware slice of the plurality of hardware slices.
29. The non-transitory computer-readable medium of any one of clauses 27-28, wherein:
   the GPU further comprises a unified cache (UCHE) communicatively coupled to each hardware slice of the plurality of hardware slices; and
   wherein the computer-executable instructions further cause the processor device to, responsive to determining that the GPU is operating in a bin foveation mode, flush an LRZ of each hardware slice of the plurality of hardware slices into the UCHE.

What is claimed is:

1. A graphics processing unit (GPU) comprising:
a plurality of hardware slices; and
a sliced low-resolution Z buffer (LRZ) communicatively coupled to each hardware slice of the plurality of hardware slices and comprising a plurality of LRZ regions;
wherein each hardware slice is configured to store, in an LRZ region corresponding exclusively to the hardware slice among the plurality of LRZ regions, a pixel tile assigned to the hardware slice.

2. The GPU of claim 1, wherein each hardware slice is configured to store the pixel tile assigned to the hardware slice by being configured to:
map screen coordinates for the pixel tile into slice coordinates;
calculate an LRZ X index, an LRZ Y index, and an LRZ offset using the slice coordinates; and
determine a block address for the pixel tile within the sliced LRZ using the LRZ X index, the LRZ Y index, and a slice pitch for the LRZ region.

3. The GPU of claim 1, wherein:
the GPU further comprises a sliced LRZ fast clear buffer communicatively coupled to each hardware slice of the plurality of hardware slices;
the sliced LRZ fast clear buffer comprises a plurality of LRZ fast clear buffer regions each corresponding to a hardware slice of the plurality of hardware slices;
each LRZ fast clear buffer region of the plurality of LRZ fast clear buffer regions comprises a fast clear bit corresponding to the pixel tile assigned to the hardware slice; and
each hardware slice of the plurality of hardware slices is further configured to update the fast clear bit corresponding to the pixel tile assigned to the hardware slice to indicate whether to clear the pixel tile.

4. The GPU of claim 3, wherein each hardware slice of the plurality of hardware slices is further configured to:
read from any of the plurality of LRZ fast clear buffer regions; and
write only to the LRZ fast clear buffer region corresponding to the hardware slice among the plurality of LRZ fast clear buffer regions.

5. The GPU of claim 1, wherein:
the GPU further comprises a sliced LRZ metadata buffer communicatively coupled to each hardware slice of the plurality of hardware slices;
the sliced LRZ metadata buffer comprises a plurality of LRZ metadata buffer regions each corresponding to a hardware slice of the plurality of hardware slices;
each LRZ metadata buffer region of the plurality of LRZ metadata buffer regions comprises a metadata indicator; and
each hardware slice of the plurality of hardware slices is further configured to update the metadata indicator of the LRZ metadata buffer region corresponding to the hardware slice.

6. The GPU of claim 5, wherein each hardware slice of the plurality of hardware slices is further configured to:
read from only the LRZ metadata buffer region corresponding to the hardware slice among the plurality of LRZ metadata buffer regions; and
write to only the LRZ metadata buffer region corresponding to the hardware slice among the plurality of LRZ metadata buffer regions.

7. The GPU of claim 1, further configured to:
determine whether the GPU is operating in a bin foveation mode; and
responsive to determining that the GPU is operating in a bin foveation mode:
fetch two or more pixel tiles from corresponding two or more hardware slices of the plurality of hardware slices;
perform a downsampling operation on the two or more pixel tiles to generate downsampled data; and
store the downsampled data in an LRZ region corresponding to the two or more pixel tiles among the plurality of LRZ regions.

8. The GPU of claim 7, further configured to, responsive to determining that the GPU is operating in a bin foveation mode:
retrieve LRZ metadata buffer data from each hardware slice of the plurality of hardware slices;
merge the LRZ metadata buffer data retrieved from each hardware slice of the plurality of hardware slices as merged LRZ metadata; and
store the merged LRZ metadata in association with a hardware slice of the plurality of hardware slices.

9. The GPU of claim 7, wherein:
the GPU further comprises a unified cache (UCHE) communicatively coupled to each hardware slice of the plurality of hardware slices; and
the GPU is further configured to, responsive to determining that the GPU is operating in a bin foveation mode, flush an LRZ of each hardware slice of the plurality of hardware slices into the UCHE.

10. The GPU of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

11. A graphics processing unit (GPU), comprising means for storing a pixel tile, assigned to a hardware slice of a plurality of hardware slices of the GPU, in a low-resolution Z buffer (LRZ) region corresponding exclusively to the hardware slice among a plurality of LRZ regions of a sliced LRZ communicatively coupled to each hardware slice of the plurality of hardware slices.

12. A method for operating a graphics processing unit (GPU) comprising a plurality of hardware slices, comprising storing, by a hardware slice of the plurality of hardware slices, a pixel tile assigned to the hardware slice in a low-resolution Z buffer (LRZ) region corresponding exclusively to the hardware slice among a plurality of LRZ regions of a sliced LRZ communicatively coupled to each hardware slice of the plurality of hardware slices.

13. The method of claim 12, wherein storing the pixel tile assigned to the hardware slice comprises:
mapping screen coordinates for the pixel tile into slice coordinates;
calculating an LRZ X index, an LRZ Y index, and an LRZ offset using the slice coordinates; and
determining a block address for the pixel tile within the sliced LRZ using the LRZ X index, the LRZ Y index, and a slice pitch for the LRZ region.

14. The method of claim 12, wherein:
the GPU further comprises a sliced LRZ fast clear buffer communicatively coupled to each hardware slice of the plurality of hardware slices;
the sliced LRZ fast clear buffer comprises a plurality of LRZ fast clear buffer regions each corresponding to a hardware slice of the plurality of hardware slices;
each LRZ fast clear buffer region of the plurality of LRZ fast clear buffer regions comprises a fast clear bit corresponding to the pixel tile assigned to the hardware slice; and
the method further comprises updating, by the hardware slice, the fast clear bit corresponding to the pixel tile assigned to the hardware slice to indicate whether to clear the pixel tile.

15. The method of claim 14, further comprising:
reading, by the hardware slice, from any of the plurality of LRZ fast clear buffer regions; and
writing, by the hardware slice, only to the LRZ fast clear buffer region corresponding to the hardware slice among the plurality of LRZ fast clear buffer regions.

16. The method of claim 12, wherein:
the GPU further comprises a sliced LRZ metadata buffer communicatively coupled to each hardware slice of the plurality of hardware slices;
the sliced LRZ metadata buffer comprises a plurality of LRZ metadata buffer regions each corresponding to a hardware slice of the plurality of hardware slices;
each LRZ metadata buffer region of the plurality of LRZ metadata buffer regions comprises a metadata indicator; and
the method further comprises updating the metadata indicator of the LRZ metadata buffer region corresponding to the hardware slice.

17. The method of claim 16, further comprising:
reading, by the hardware slice, from only the LRZ metadata buffer region corresponding to the hardware slice among the plurality of LRZ metadata buffer regions; and
writing, by the hardware slice, to only the LRZ metadata buffer region corresponding to the hardware slice among the plurality of LRZ metadata buffer regions.

18. The method of claim 12, further comprising:
determining, by the GPU, that the GPU is operating in a bin foveation mode; and
responsive to determining that the GPU is operating in a bin foveation mode:
fetching two or more pixel tiles from corresponding two or more hardware slices of the plurality of hardware slices;
performing a downsampling operation on the two or more pixel tiles to generate downsampled data; and
storing the downsampled data in an LRZ region corresponding to the two or more pixel tiles among the plurality of LRZ regions.

19. The method of claim 18, further comprising, responsive to determining that the GPU is operating in a bin foveation mode:
retrieving LRZ metadata buffer data from each hardware slice of the plurality of hardware slices;
merging the LRZ metadata buffer data retrieved from each hardware slice of the plurality of hardware slices as merged LRZ metadata; and
storing the merged LRZ metadata in association with a hardware slice of the plurality of hardware slices.

20. The method of claim 18, wherein:
the GPU further comprises a unified cache (UCHE) communicatively coupled to each hardware slice of the plurality of hardware slices; and
the method further comprises, responsive to determining that the GPU is operating in a bin foveation mode, flushing an LRZ of each hardware slice of the plurality of hardware slices into the UCHE.

21. A non-transitory computer-readable medium having stored thereon computer-executable instructions which, when executed by a processor device of a processor-based device, cause the processor device to store a pixel tile, assigned to a hardware slice of a plurality of hardware slices of a graphics processing unit (GPU) of the processor-based device, in a low-resolution Z buffer (LRZ) region corresponding exclusively to the hardware slice among a plurality of LRZ regions of a sliced LRZ communicatively coupled to each hardware slice of the plurality of hardware slices.

22. The non-transitory computer-readable medium of claim 21, wherein the computer-executable instructions cause the processor device to store the pixel tile assigned to the hardware slice by causing the processor device to:
map screen coordinates for the pixel tile into slice coordinates;
calculate an LRZ X index, an LRZ Y index, and an LRZ offset using the slice coordinates; and
determine a block address for the pixel tile within the sliced LRZ using the LRZ X index, the LRZ Y index, and a slice pitch for the LRZ region.

23. The non-transitory computer-readable medium of claim 21, wherein:
the GPU further comprises a sliced LRZ fast clear buffer communicatively coupled to each hardware slice of the plurality of hardware slices;
the sliced LRZ fast clear buffer comprises a plurality of LRZ fast clear buffer regions each corresponding to a hardware slice of the plurality of hardware slices;
each LRZ fast clear buffer region of the plurality of LRZ fast clear buffer regions comprises a fast clear bit corresponding to the pixel tile assigned to the hardware slice; and
the computer-executable instructions further cause the processor device to update the fast clear bit corresponding to the pixel tile assigned to the hardware slice to indicate whether to clear the pixel tile.

24. The non-transitory computer-readable medium of claim 23, wherein the computer-executable instructions further cause the processor device to:
read from any of the plurality of LRZ fast clear buffer regions; and
write only to the LRZ fast clear buffer region corresponding to the hardware slice among the plurality of LRZ fast clear buffer regions.

25. The non-transitory computer-readable medium of claim 21, wherein:
the GPU further comprises a sliced LRZ metadata buffer communicatively coupled to each hardware slice of the plurality of hardware slices;
the sliced LRZ metadata buffer comprises a plurality of LRZ metadata buffer regions each corresponding to a hardware slice of the plurality of hardware slices;
each LRZ metadata buffer region of the plurality of LRZ metadata buffer regions comprises a metadata indicator; and
the computer-executable instructions further cause the processor device to update the metadata indicator of the LRZ metadata buffer region corresponding to the hardware slice.

26. The non-transitory computer-readable medium of claim 25, wherein the computer-executable instructions further cause the processor device to:
read from only the LRZ metadata buffer region corresponding to the hardware slice among the plurality of LRZ metadata buffer regions; and
write to only the LRZ metadata buffer region corresponding to the hardware slice among the plurality of LRZ metadata buffer regions.

27. The non-transitory computer-readable medium of claim 21, wherein the computer-executable instructions further cause the processor device to:
determine whether the GPU is operating in a bin foveation mode; and
responsive to determining that the GPU is operating in a bin foveation mode:
fetch two or more pixel tiles from corresponding two or more hardware slices of the plurality of hardware slices;
perform a downsampling operation on the two or more pixel tiles to generate downsampled data; and
store the downsampled data in an LRZ region corresponding to the two or more pixel tiles among the plurality of LRZ regions.

28. The non-transitory computer-readable medium of claim 27, wherein the computer-executable instructions further cause the processor device to, responsive to determining that the GPU is operating in a bin foveation mode:
retrieve LRZ metadata buffer data from each hardware slice of the plurality of hardware slices;
merge the LRZ metadata buffer data retrieved from each hardware slice of the plurality of hardware slices as merged LRZ metadata; and
store the merged LRZ metadata in association with a hardware slice of the plurality of hardware slices.

29. The non-transitory computer-readable medium of claim 27, wherein:
the GPU further comprises a unified cache (UCHE) communicatively coupled to each hardware slice of the plurality of hardware slices; and
wherein the computer-executable instructions further cause the processor device to, responsive to determining that the GPU is operating in a bin foveation mode, flush an LRZ of each hardware slice of the plurality of hardware slices into the UCHE.
